(19) United States
(12) Patent Application Publication
(10) Pub. No.: US 2023/0142542 A1
(43) Pub. Date: May 11, 2023

(54) USE OF SUBSTITUTED 1,2,4-OXADIAZOLES FOR COMBATING PHYTOPATHOGENIC FUNGI

(71) Applicant: BASF SE, Ludwigshafen (DE)

(72) Inventors: Wassilios Grammenos, Ludwigshafen (DE); Lutz Brahm, Limburgerhof (DE); Thomas Grote, Limburgerhof (DE); Bernd Mueller, Ludwigshafen (DE); Ian Robert Craig, Ludwigshafen (DE); Christian Harald Winter, Ludwigshafen (DE); Benjamin Juergen Merget, Ludwigshafen (DE); Georg Christoph Rudolf, Ludwigshafen (DE); Jan Klaas Lohmann, Ludwigshafen (DE); Tim Alexander Stoesser, Ludwigshafen (DE); Michael Seet, Ludwigshafen (DE); Marcus Fehr, Limburgerhof (DE); Andreas Koch, Limburgerhof (DE)

(21) Appl. No.: 17/908,612

(22) PCT Filed: Feb. 24, 2021
(86) PCT No.: PCT/EP2021/054491

§ 371 Date: Sep. 1, 2022

(30) Foreign Application Priority Data
Mar. 4, 2020 (EP) 20160863.5
Mar. 18, 2020 (EP) 20163948.1

(51) Int. Cl. A01N 43/82; A01P 3/00

(52) U.S. Cl. CPC A01N 43/82; A01P 3/00

(57) ABSTRACT

The present invention relates the use of compounds of the formula I, or their N-oxides, or the agriculturally acceptable salts thereof, for combating phytopathogenic harmful fungi. Further the present invention relates to agrochemical compositions comprising at least one such compound of the formula I and to agrochemical compositions further comprising seeds.

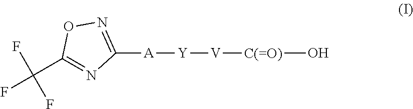

The present invention relates the use of compounds of the formula I, or their N-oxides, or the agriculturally acceptable salts thereof, for combating phytopathogenic harmful fungi. Further the present invention relates to agrochemical compositions comprising at least one such compound of the formula I and to agrochemical compositions further comprising seeds.

Tale et al. in Journal of Chemical and Pharmaceutical Research 2011, 3(2), 496-505 discloses benzoate type 1,2,4-oxadiazoles and their use for combating phytopathogenic fungi. WO 2015/185485 also relates to benzoate type 1,2,4-oxadiazoles and their use as fungicides. WO 2017/076742 inter alia relates to 2-[[5-(trifluoromethyl)-1,2,4-oxadiazol-3-yl]aryl](thio)acetamide derivatives and to their use to combat phytopathogenic microorganisms. WO 2018/234139 relates to 2-[[5-(trifluoromethyl)-1,2,4-oxadiazol-3-yl]aryloxy](thio)acetamides for combating phytopathogenic fungi.

In many cases, in particular at low application rates, the fungicidal activity of known fungicidal compounds is unsatisfactory. Based on this, it was an objective of the present invention to provide compounds having improved activity and/or a broader activity spectrum against phytopathogenic fungi. This objective is achieved by the oxadiazoles of the formula I and/or their agriculturally useful salts for controlling phytopathogenic fungi.

Accordingly, the present invention relates to the use of compounds of the formula I, or the N-oxides, or the agriculturally acceptable salts thereof, for combating phytopathogenic fungi,

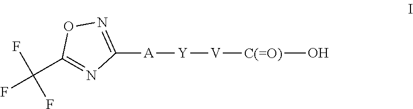

wherein:
A is phenyl or a 5- or 6-membered aromatic heterocycle; wherein the ring member atoms of the aromatic heterocycle include besides carbon atoms 1, 2, 3 or 4 heteroatoms selected from N, O and S as ring member atoms; and with the provision that the aromatic heterocycle cannot contain 2 contiguous atoms selected from O and S; and wherein the phenyl ring or the 5- or 6-membered aromatic heterocycle is unsubstituted or substituted with n identical or different groups R^{A}; wherein
   n is 0, 1, 2, 3, or 4;
   R^{A} is halogen, cyano, C₁-C₆-alkyl, C₁-C₆-haloalkyl, C₁-C₆-alkoxy, or C₁-C₆-haloalkoxy;
Y is a direct bond, —O—, or —S—;
V is a divalent moiety —CR³R⁴—; wherein
   R³, R⁴ independently of each other are selected from the group consisting of hydrogen, hydroxy, halogen, cyano, C₁-C₄-alkyl, C₂-C₄-alkenyl, C₂-C₄-alkynyl, C₁-C₄-alkoxy C₁-C₄-haloalkyl, and C₁-C₄-haloalkoxy; or R³ and R⁴ together with the carbon atom to which they are bound form a cyclopropyl ring;
   or, if Y is a direct bond, V is absent.

Agriculturally acceptable salts of the compounds of the formula I encompass especially the salts of those cations or the acid addition salts of those acids whose cations and anions, respectively, have no adverse effect on the fungicidal action of the compounds I. Suitable cations are thus in particular the ions of the alkali metals, preferably sodium and potassium, of the alkaline earth metals, preferably calcium, magnesium and barium, of the transition metals, preferably manganese, copper, zinc and iron, and also the ammonium ion which, if desired, may carry one to four C₁-C₄-alkyl substituents and/or one phenyl or benzyl substituent, preferably diisopropylammonium, tetramethylammonium, tetrabutylammonium, trimethylbenzylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of acceptable acid addition salts are primarily chloride, bromide, fluoride, hydrogensulfate, sulfate, dihydrogenphosphate, hydrogenphosphate, phosphate, nitrate, bicarbonate, carbonate, hexafluorosilicate, hexafluorophosphate, benzoate, and the anions of C₁-C₄-alkanoic acids, preferably formate, acetate, propionate and butyrate. They can be formed by reacting a compound I with an acid of the corresponding anion, preferably of hydrochloric acid, hydrobromic acid, sulfuric acid, phosphoric acid or nitric acid.

Compounds of the formula I can exist as one or more stereoisomers. The various stereoisomers include enantiomers, diastereomers, atropisomers arising from restricted rotation about a single bond of asymmetric groups and geometric isomers. They also form part of the subject matter of the present invention. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. The compounds of the invention may be present as a mixture of stereoisomers, e.g. a racemate, individual stereoisomers, or as an optically active form.

Compounds of the formula I can be present in different crystal modifications whose biological activity may differ. They also form part of the subject matter of the present invention.

In respect of the variables, the embodiments of the intermediates obtained during preparation of compounds I correspond to the embodiments of the compounds of formula I. The term “compounds I” refers to compounds of formula I.

In the definitions of the variables given above, collective terms are used which are generally representative for the substituents in question. The term “Cₙ-Cₘ” indicates the number of carbon atoms possible in each case in the substituent or substituent moiety in question.

The term “halogen” refers to fluorine, chlorine, bromine and iodine.

The term “C₁-C₆-alkyl” refers to a straight-chained or branched saturated hydrocarbon group having 1 to 6 carbon atoms, for example methyl, ethyl, propyl, 1-methylethyl, butyl, 1-methylpropyl, 2-methylpropyl, and 1,1-dimethylethyl.

The term “C₁-C₆-haloalkyl” refers to a straight-chained or branched alkyl group having 1 to 6 carbon atoms (as defined above), wherein some or all of the hydrogen atoms in these groups may be replaced by halogen atoms as mentioned above, for example chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl and pentafluoroethyl, 2-fluoropropyl, 3-fluoropropyl, 2,2-difluoropropyl, 2,3-difluoropropyl, 2-chloropropyl, 3-chloropropyl, 2,3-dichloropropyl, 2-bromopropyl, 3-bromopropyl, 3,3,3-trifluoropropyl, 3,3,3-trichloropropyl, CH₂—C₂F₅, CF₂—C₂F₅, CF(CF₃)₂, 1-(fluoromethyl)-2-fluoroethyl, 1-(chloromethyl)-2-chloroethyl, 1-(bromomethyl)-2-bromoethyl, 4-fluorobutyl, 4-chlorobutyl, 4-bromobutyl or nonafluorobutyl.

The term “C₁-C₆-alkoxy” refers to a straight-chain or branched alkyl group having 1 to 6 carbon atoms (as defined above) which is bonded via an oxygen, at any position in the alkyl group, for example methoxy, ethoxy, n-propoxy, 1-methylethoxy, butoxy, 1-methylpropoxy, 2-methylpropoxy or 1,1-dimethylethoxy.

The term “C₁-C₆-haloalkoxy” refers to a C₁-C₆-alkoxy group as defined above, wherein some or all of the hydrogen atoms may be replaced by halogen atoms as mentioned above, for example, OCH₂F, OCHF₂, OCF₃, OCH₂Cl, OCHCl₂, OCCl₃, chlorofluoromethoxy, dichlorofluoromethoxy, chlorodifluoromethoxy, 2-fluoroethoxy, 2-chloroethoxy, 2-bromoethoxy, 2-iodoethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, OC₂F₅, 2-fluoropropoxy, 3-fluoropropoxy, 2,2-difluoropropoxy, 2,3-difluoropropoxy, 2-chloropropoxy, 3-chloropropoxy, 2,3-dichloropropoxy, 2-bromopropoxy, 3-bromopropoxy, 3,3,3-trifluoropropoxy, 3,3,3-trichloropropoxy, OCH₂—C₂F₅, OCF₂—C₂F₅, 1-(CH₂F)-2-fluoroethoxy, 1-(CH₂Cl)-2-chloroethoxy, 1-(CH₂Br)-2-bromo¬ethoxy, 4-fluorobutoxy, 4-chlorobutoxy, 4-bromobutoxy or nonafluorobutoxy.

The term “C₂-C₄-alkenyl” refers to a straight-chain or branched unsaturated hydrocarbon radical having 2 to 4 carbon atoms and containing at least one double bond, such as vinyl, 1-propenyl, 2-propenyl (allyl), 1-butenyl, 2-butenyl, 3-butenyl, 1-methyl-2-propenyl.

The term “C₂-C₄-alkynyl” refers to a straight-chain or branched unsaturated hydrocarbon radical having 2 to 4 carbon atoms and containing at least one triple bond, such as ethynyl, 1-propynyl, 2-propynyl (propargyl), 1-butynyl, 2-butynyl, 3-butynyl, 1-methyl-2-propynyl.

In regard to the group A the terms “phenyl, thiophenyl, pyridinyl, pyrimidinyl, pyridazinyl, or pyrazinyl” are to be interpreted as an aromatic ring, which is attached to both, the oxadiazole moiety and the group —Y—V—C(═O)OH.

Preference is given to those compounds I and, where applicable, also to compounds of all subformulae provided herein, wherein all variables have independently of each other or more preferably in combination (any possible combination of 2 or more substituents as defined herein) the following meanings:

In one aspect of the present invention (embodiment A.1) the cyclic moiety A is a phenyl, thiophenyl, pyridinyl, pyrimidinyl, pyridazinyl, or pyrazinyl ring; and wherein A is unsubstituted or substituted with 1, 2, 3 or 4 identical or different groups R^{A} and wherein R^{A} is as defined herein for compounds I or as preferably defined in any one of embodiments R^{A}.1 to R^{A}.3 below.

Embodiment A.2: A is a phenyl wherein the phenyl is unsubstituted or substituted with 1, 2, 3 or 4 identical or different groups R^{A} and wherein R^{A} is as defined herein for compounds I or as preferably defined in any one of embodiments R^{A}.1 to R^{A}.3 below.

Embodiment A.3: A is defined as in subformulae (a.1) to (a.6),

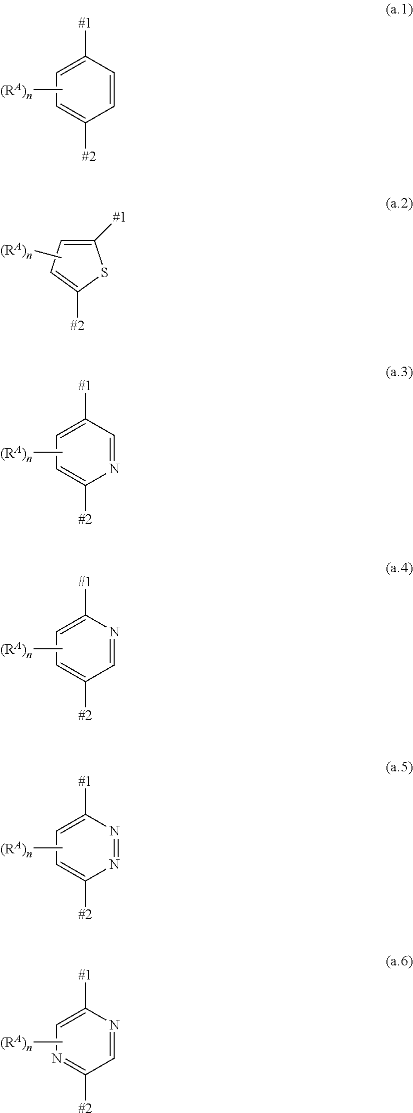

wherein n is 0, 1, 2, or 3, R^{A} is as defined herein for compounds I, and wherein #1 denotes the position which is bound to the trifluoromethyloxadiazole moiety and #2 denotes the position, which is connected to the group —Y—V—C(═O)OH.

Embodiment A.4: is based on embodiment A.3, and wherein n is 0, 1, or 2 and R^{A} is as defined herein for compounds I, or as preferably defined in any one of embodiments R^{A}.1 to R^{A}.3 below.

Embodiment A.5: A as defined in any one of subformulae (a.1) to (a.6), and wherein n is 0, 1, or 2 and R^{A} is as defined in embodiment R^{A}.2.

Embodiment A.6: A as defined in any one of subformulae (a.1) to (a.6) and n is 0.

Embodiment A.7: A is as defined in subformula (a.1), wherein n is 0, 1, 2, or 3, R^{A} is as defined herein for compounds I or as preferably defined in any one of embodiments R^{A}.1 to R^{A}.3 below and wherein #1 denotes the position which is bound to the trifluoromethyloxadiazole moiety and #2 denotes the position, which is connected to the group —Y—V—C(═O)OH.

In a preferred embodiment (embodiment R^{A}.1) of the invention R^{A} is chlorine, fluorine, methyl, methoxy, trifluoromethyl, trifluoromethoxy, difluoromethy or difluoromethoxy.

Embodiment R^{A}.2: R^{A} is chlorine, fluorine, methyl, or methoxy.

Embodiment R^{A}.3: R^{A} is fluorine.

In one aspect of the invention n is 0, 1 or 2. In another aspect of the invention n is 0 or 1.

In yet another aspect of the invention n is 0 or 1; and R^{A} is fluorine.

In a preferred aspect of the invention n is 0.

Embodiment Y.1: Y is —O—. Embodiment Y.2: Y is a direct bond.

In one aspect (embodiment V.1) of the invention V is a divalent moiety —CR³R⁴—, wherein R³ and R⁴ are as defined for compounds I herein, or V is absent.

Embodiment V.2: V is a divalent moiety —CR³R⁴—, wherein R³ and R⁴ are as defined for compounds I herein.

Embodiment V.3: V is a divalent moiety —CR³R⁴—, wherein R³ and R⁴ independently of each other are selected from the group consisting of hydrogen, fluorine, methyl, trifluoromethyl, and —OCHF₂; or R³ and R⁴ together with the carbon atom to which they are bound form a cyclopropyl ring.

Embodiment V.4: V is a divalent moiety —CR³R⁴—, wherein R³ and R⁴ independently of each other are selected from the group consisting of hydrogen, fluorine, or methyl.

Embodiment V.5: V is a divalent moiety —CR³R⁴—, wherein R³ and R⁴ are both fluorine.

Embodiment V.6: Y is a direct bond (embodiment Y.2) and V is absent.

In another embodiment Y is —O— or a direct bond and V is a divalent moiety —CR³R⁴—.

In further aspects the present invention relates to the embodiments E.1 to E.240 listed in Table E, which represent preferred combinations of embodiments that are defined above for each of the variables A (represented by subformulae (a) to (a.6)), n, R^{A} (represented by embodiments R^{A}.1 to R^{A}.3), Y (represented by embodiments Y.1 and Y.2), and V (represented by embodiments V.1 to V.6) in compounds of formula I.

TABLE E

| Embodiment | A | n | R^{A} | Y | V |
|---|---|---|---|---|---|
| E.1 | (a.1) | 0, 1, or 2 | R^{A}.1 | Y.2 | V.1 |
| E.2 | (a.2) | 0, 1, or 2 | R^{A}.1 | Y.2 | V.1 |
| E.3 | (a.3) | 0, 1, or 2 | R^{A}.1 | Y.2 | V.1 |
| E.4 | (a.4) | 0, 1, or 2 | R^{A}.1 | Y.2 | V.1 |
| E.5 | (a.5) | 0, 1, or 2 | R^{A}.1 | Y.2 | V.1 |
| E.6 | (a.6) | 0, 1, or 2 | R^{A}.1 | Y.2 | V.1 |
| E.7 | (a.1) | 0 or 1 | R^{A}.2 | Y.2 | V.1 |
| E.8 | (a.2) | 0 or 1 | R^{A}.2 | Y.2 | V.1 |
| E.9 | (a.3) | 0 or 1 | R^{A}.2 | Y.2 | V.1 |
| E.10 | (a.4) | 0 or 1 | R^{A}.2 | Y.2 | V.1 |
| E.11 | (a.5) | 0 or 1 | R^{A}.2 | Y.2 | V.1 |
| E.12 | (a.6) | 0 or 1 | R^{A}.2 | Y.2 | V.1 |
| E.13 | (a.1) | 0 or 1 | R^{A}.3 | Y.2 | V.1 |
| E.14 | (a.2) | 0 or 1 | R^{A}.3 | Y.2 | V.1 |
| E.15 | (a.3) | 0 or 1 | R^{A}.3 | Y.2 | V.1 |
| E.16 | (a.4) | 0 or 1 | R^{A}.3 | Y.2 | V.1 |
| E.17 | (a.5) | 0 or 1 | R^{A}.3 | Y.2 | V.1 |
| E.18 | (a.6) | 0 or 1 | R^{A}.3 | Y.2 | V.1 |
| E.19 | (a.1) | 0 | — | Y.2 | V.1 |
| E.20 | (a.2) | 0 | — | Y.2 | V.1 |
| E.21 | (a.3) | 0 | — | Y.2 | V.1 |
| E.22 | (a.4) | 0 | — | Y.2 | V.1 |
| E.23 | (a.5) | 0 | — | Y.2 | V.1 |
| E.24 | (a.6) | 0 | — | Y.2 | V.1 |
| E.25 | (a.1) | 0, 1, 2 | R^{A}.1 | Y.1 | V.2 |
| E.26 | (a.2) | 0, 1, 2 | R^{A}.1 | Y.1 | V.2 |
| E.27 | (a.3) | 0, 1, 2 | R^{A}.1 | Y.1 | V.2 |
| E.28 | (a.4) | 0, 1, 2 | R^{A}.1 | Y.1 | V.2 |
| E.29 | (a.5) | 0, 1, 2 | R^{A}.1 | Y.1 | V.2 |
| E.30 | (a.6) | 0, 1, 2 | R^{A}.1 | Y.1 | V.2 |
| E.31 | (a.1) | 0 or 1 | R^{A}.2 | Y.1 | V.2 |
| E.32 | (a.2) | 0 or 1 | R^{A}.2 | Y.1 | V.2 |
| E.33 | (a.3) | 0 or 1 | R^{A}.2 | Y.1 | V.2 |
| E.34 | (a.4) | 0 or 1 | R^{A}.2 | Y.1 | V.2 |
| E.35 | (a.5) | 0 or 1 | R^{A}.2 | Y.1 | V.2 |
| E.36 | (a.6) | 0 or 1 | R^{A}.2 | Y.1 | V.2 |
| E.37 | (a.1) | 0 or 1 | R^{A}.3 | Y.1 | V.2 |
| E.38 | (a.2) | 0 or 1 | R^{A}.3 | Y.1 | V.2 |
| E.39 | (a.3) | 0 or 1 | R^{A}.3 | Y.1 | V.2 |
| E.40 | (a.4) | 0 or 1 | R^{A}.3 | Y.1 | V.2 |
| E.41 | (a.5) | 0 or 1 | R^{A}.3 | Y.1 | V.2 |
| E.42 | (a.6) | 0 or 1 | R^{A}.3 | Y.1 | V.2 |
| E.43 | (a.1) | 0 | — | Y.1 | V.2 |
| E.44 | (a.2) | 0 | — | Y.1 | V.2 |
| E.45 | (a.3) | 0 | — | Y.1 | V.2 |
| E.46 | (a.4) | 0 | — | Y.1 | V.2 |
| E.47 | (a.5) | 0 | — | Y.1 | V.2 |
| E.48 | (a.6) | 0 | — | Y.1 | V.2 |
| E.49 | (a.1) | 0, 1, or 2 | R^{A}.1 | Y.2 | V.2 |
| E.50 | (a.2) | 0, 1, or 2 | R^{A}.1 | Y.2 | V.2 |
| E.51 | (a.3) | 0, 1, or 2 | R^{A}.1 | Y.2 | V.2 |
| E.52 | (a.4) | 0, 1, or 2 | R^{A}.1 | Y.2 | V.2 |
| E.53 | (a.5) | 0, 1, or 2 | R^{A}.1 | Y.2 | V.2 |
| E.54 | (a.6) | 0, 1, or 2 | R^{A}.1 | Y.2 | V.2 |
| E.55 | (a.1) | 0 or 1 | R^{A}.2 | Y.2 | V.2 |
| E.56 | (a.2) | 0 or 1 | R^{A}.2 | Y.2 | V.2 |
| E.57 | (a.3) | 0 or 1 | R^{A}.2 | Y.2 | V.2 |
| E.58 | (a.4) | 0 or 1 | R^{A}.2 | Y.2 | V.2 |
| E.59 | (a.5) | 0 or 1 | R^{A}.2 | Y.2 | V.2 |
| E.60 | (a.6) | 0 or 1 | R^{A}.2 | Y.2 | V.2 |
| E.61 | (a.1) | 0 or 1 | R^{A}.3 | Y.2 | V.2 |
| E.62 | (a.2) | 0 or 1 | R^{A}.3 | Y.2 | V.2 |
| E.63 | (a.3) | 0 or 1 | R^{A}.3 | Y.2 | V.2 |
| E.64 | (a.4) | 0 or 1 | R^{A}.3 | Y.2 | V.2 |
| E.65 | (a.5) | 0 or 1 | R^{A}.3 | Y.2 | V.2 |
| E.66 | (a.6) | 0 or 1 | R^{A}.3 | Y.2 | V.2 |
| E.67 | (a.1) | 0 | — | Y.2 | V.2 |
| E.68 | (a.2) | 0 | — | Y.2 | V.2 |
| E.69 | (a.3) | 0 | — | Y.2 | V.2 |
| E.70 | (a.4) | 0 | — | Y.2 | V.2 |
| E.71 | (a.5) | 0 | — | Y.2 | V.2 |
| E.72 | (a.6) | 0 | — | Y.2 | V.2 |
| E.73 | (a.1) | 0, 1, or 2 | R^{A}.1 | Y.1 | V.3 |
| E.74 | (a.2) | 0, 1, or 2 | R^{A}.1 | Y.1 | V.3 |
| E.75 | (a.3) | 0, 1, or 2 | R^{A}.1 | Y.1 | V.3 |
| E.76 | (a.4) | 0, 1, or 2 | R^{A}.1 | Y.1 | V.3 |
| E.77 | (a.5) | 0, 1, or 2 | R^{A}.1 | Y.1 | V.3 |
| E.78 | (a.6) | 0, 1, or 2 | R^{A}.1 | Y.1 | V.3 |
| E.79 | (a.1) | 0 or 1 | R^{A}.2 | Y.1 | V.3 |
| E.80 | (a.2) | 0 or 1 | R^{A}.2 | Y.1 | V.3 |
| E.81 | (a.3) | 0 or 1 | R^{A}.2 | Y.1 | V.3 |
| E.82 | (a.4) | 0 or 1 | R^{A}.2 | Y.1 | V.3 |
| E.83 | (a.5) | 0 or 1 | R^{A}.2 | Y.1 | V.3 |
| E.84 | (a.6) | 0 or 1 | R^{A}.2 | Y.1 | V.3 |
| E.85 | (a.1) | 0 or 1 | R^{A}.3 | Y.1 | V.3 |
| E.86 | (a.2) | 0 or 1 | R^{A}.3 | Y.1 | V.3 |
| E.87 | (a.3) | 0 or 1 | R^{A}.3 | Y.1 | V.3 |
| E.88 | (a.4) | 0 or 1 | R^{A}.3 | Y.1 | V.3 |
| E.89 | (a.5) | 0 or 1 | R^{A}.3 | Y.1 | V.3 |
| E.90 | (a.6) | 0 or 1 | R^{A}.3 | Y.1 | V.3 |
| E.91 | (a.1) | 0 | — | Y.1 | V.3 |
| E.92 | (a.2) | 0 | — | Y.1 | V.3 |
| E.93 | (a.3) | 0 | — | Y.1 | V.3 |
| E.94 | (a.4) | 0 | — | Y.1 | V.3 |
| E.95 | (a.5) | 0 | — | Y.1 | V.3 |
| E.96 | (a.6) | 0 | — | Y.1 | V.3 |
| E.97 | (a.1) | 0, 1, or 2 | R^{A}.1 | Y.2 | V.3 |
| E.98 | (a.2) | 0, 1, or 2 | R^{A}.1 | Y.2 | V.3 |
| E.99 | (a.3) | 0, 1, or 2 | R^{A}.1 | Y.2 | V.3 |
| E.100 | (a.4) | 0, 1, or 2 | R^{A}.1 | Y.2 | V.3 |
| E.101 | (a.5) | 0, 1, or 2 | R^{A}.1 | Y.2 | V.3 |
| E.102 | (a.6) | 0, 1, or 2 | R^{A}.1 | Y.2 | V.3 |
| E.103 | (a.1) | 0 or 1 | R^{A}.2 | Y.2 | V.3 |
| E.104 | (a.2) | 0 or 1 | R^{A}.2 | Y.2 | V.3 |
| E.105 | (a.3) | 0 or 1 | R^{A}.2 | Y.2 | V.3 |
| E.106 | (a.4) | 0 or 1 | R^{A}.2 | Y.2 | V.3 |
| E.107 | (a.5) | 0 or 1 | R^{A}.2 | Y.2 | V.3 |
| E.108 | (a.6) | 0 or 1 | R^{A}.2 | Y.2 | V.3 |
| E.109 | (a.1) | 0 or 1 | R^{A}.3 | Y.2 | V.3 |
| E.110 | (a.2) | 0 or 1 | R^{A}.3 | Y.2 | V.3 |
| E.111 | (a.3) | 0 or 1 | R^{A}.3 | Y.2 | V.3 |
| E.112 | (a.4) | 0 or 1 | R^{A}.3 | Y.2 | V.3 |
| E.113 | (a.5) | 0 or 1 | R^{A}.3 | Y.2 | V.3 |
| E.114 | (a.6) | 0 or 1 | R^{A}.3 | Y.2 | V.3 |
| E.115 | (a.1) | 0 | — | Y.2 | V.3 |
| E.116 | (a.2) | 0 | — | Y.2 | V.3 |
| E.117 | (a.3) | 0 | — | Y.2 | V.3 |
| E.118 | (a.4) | 0 | — | Y.2 | V.3 |
| E.119 | (a.5) | 0 | — | Y.2 | V.3 |
| E.120 | (a.6) | 0 | — | Y.2 | V.3 |
| E.121 | (a.1) | 0, 1, 2 | R^{A}.1 | Y.1 | V.4 |
| E.122 | (a.2) | 0, 1, 2 | R^{A}.1 | Y.1 | V.4 |
| E.123 | (a.3) | 0, 1, 2 | R^{A}.1 | Y.1 | V.4 |
| E.124 | (a.4) | 0, 1, 2 | R^{A}.1 | Y.1 | V.4 |
| E.125 | (a.5) | 0, 1, 2 | R^{A}.1 | Y.1 | V.4 |
| E.126 | (a.6) | 0, 1, 2 | R^{A}.1 | Y.1 | V.4 |
| E.127 | (a.1) | 0 or 1 | R^{A}.2 | Y.1 | V.4 |
| E.128 | (a.2) | 0 or 1 | R^{A}.2 | Y.1 | V.4 |
| E.129 | (a.3) | 0 or 1 | R^{A}.2 | Y.1 | V.4 |
| E.130 | (a.4) | 0 or 1 | R^{A}.2 | Y.1 | V.4 |
| E.131 | (a.5) | 0 or 1 | R^{A}.2 | Y.1 | V.4 |
| E.132 | (a.6) | 0 or 1 | R^{A}.2 | Y.1 | V.4 |
| E.133 | (a.1) | 0 or 1 | R^{A}.3 | Y.1 | V.4 |
| E.134 | (a.2) | 0 or 1 | R^{A}.3 | Y.1 | V.4 |
| E.135 | (a.3) | 0 or 1 | R^{A}.3 | Y.1 | V.4 |
| E.136 | (a.4) | 0 or 1 | R^{A}.3 | Y.1 | V.4 |
| E.137 | (a.5) | 0 or 1 | R^{A}.3 | Y.1 | V.4 |
| E.138 | (a.6) | 0 or 1 | R^{A}.3 | Y.1 | V.4 |
| E.139 | (a.1) | 0 | — | Y.1 | V.4 |
| E.140 | (a.2) | 0 | — | Y.1 | V.4 |
| E.141 | (a.3) | 0 | — | Y.1 | V.4 |
| E.142 | (a.4) | 0 | — | Y.1 | V.4 |
| E.143 | (a.5) | 0 | — | Y.1 | V.4 |
| E.144 | (a.6) | 0 | — | Y.1 | V.4 |
| E.145 | (a.1) | 0, 1, or 2 | R^{A}.1 | Y.2 | V.4 |
| E.146 | (a.2) | 0, 1, or 2 | R^{A}.1 | Y.2 | V.4 |
| E.147 | (a.3) | 0, 1, or 2 | R^{A}.1 | Y.2 | V.4 |
| E.148 | (a.4) | 0, 1, or 2 | R^{A}.1 | Y.2 | V.4 |
| E.149 | (a.5) | 0, 1, or 2 | R^{A}.1 | Y.2 | V.4 |
| E.150 | (a.6) | 0, 1, or 2 | R^{A}.1 | Y.2 | V.4 |
| E.151 | (a.1) | 0 or 1 | R^{A}.2 | Y.2 | V.4 |
| E.152 | (a.2) | 0 or 1 | R^{A}.2 | Y.2 | V.4 |
| E.153 | (a.3) | 0 or 1 | R^{A}.2 | Y.2 | V.4 |
| E.154 | (a.4) | 0 or 1 | R^{A}.2 | Y.2 | V.4 |
| E.155 | (a.5) | 0 or 1 | R^{A}.2 | Y.2 | V.4 |
| E.156 | (a.6) | 0 or 1 | R^{A}.2 | Y.2 | V.4 |
| E.157 | (a.1) | 0 or 1 | R^{A}.3 | Y.2 | V.4 |
| E.158 | (a.2) | 0 or 1 | R^{A}.3 | Y.2 | V.4 |
| E.159 | (a.3) | 0 or 1 | R^{A}.3 | Y.2 | V.4 |
| E.160 | (a.4) | 0 or 1 | R^{A}.3 | Y.2 | V.4 |
| E.161 | (a.5) | 0 or 1 | R^{A}.3 | Y.2 | V.4 |
| E.162 | (a.6) | 0 or 1 | R^{A}.3 | Y.2 | V.4 |
| E.163 | (a.1) | 0 | — | Y.2 | V.4 |
| E.164 | (a.2) | 0 | — | Y.2 | V.4 |
| E.165 | (a.3) | 0 | — | Y.2 | V.4 |
| E.166 | (a.4) | 0 | — | Y.2 | V.4 |
| E.167 | (a.5) | 0 | — | Y.2 | V.4 |
| E.168 | (a.6) | 0 | — | Y.2 | V.4 |
| E.169 | (a.1) | 0, 1, or 2 | R^{A}.1 | Y.1 | V.5 |
| E.170 | (a.2) | 0, 1, or 2 | R^{A}.1 | Y.1 | V.5 |
| E.171 | (a.3) | 0, 1, or 2 | R^{A}.1 | Y.1 | V.5 |
| E.172 | (a.4) | 0, 1, or 2 | R^{A}.1 | Y.1 | V.5 |
| E.173 | (a.5) | 0, 1, or 2 | R^{A}.1 | Y.1 | V.5 |
| E.174 | (a.6) | 0, 1, or 2 | R^{A}.1 | Y.1 | V.5 |
| E.175 | (a.1) | 0 or 1 | R^{A}.2 | Y.1 | V.5 |
| E.176 | (a.2) | 0 or 1 | R^{A}.2 | Y.1 | V.5 |
| E.177 | (a.3) | 0 or 1 | R^{A}.2 | Y.1 | V.5 |
| E.178 | (a.4) | 0 or 1 | R^{A}.2 | Y.1 | V.5 |
| E.179 | (a.5) | 0 or 1 | R^{A}.2 | Y.1 | V.5 |
| E.180 | (a.6) | 0 or 1 | R^{A}.2 | Y.1 | V.5 |
| E.181 | (a.1) | 0 or 1 | R^{A}.3 | Y.1 | V.5 |
| E.182 | (a.2) | 0 or 1 | R^{A}.3 | Y.1 | V.5 |
| E.183 | (a.3) | 0 or 1 | R^{A}.3 | Y.1 | V.5 |
| E.184 | (a.4) | 0 or 1 | R^{A}.3 | Y.1 | V.5 |
| E.185 | (a.5) | 0 or 1 | R^{A}.3 | Y.1 | V.5 |
| E.186 | (a.6) | 0 or 1 | R^{A}.3 | Y.1 | V.5 |
| E.187 | (a.1) | 0 | — | Y.1 | V.5 |
| E.188 | (a.2) | 0 | — | Y.1 | V.5 |
| E.189 | (a.3) | 0 | — | Y.1 | V.5 |
| E.190 | (a.4) | 0 | — | Y.1 | V.5 |
| E.191 | (a.5) | 0 | — | Y.1 | V.5 |
| E.192 | (a.6) | 0 | — | Y.1 | V.5 |
| E.193 | (a.1) | 0, 1, or 2 | R^{A}.1 | Y.2 | V.5 |
| E.194 | (a.2) | 0, 1, or 2 | R^{A}.1 | Y.2 | V.5 |
| E.195 | (a.3) | 0, 1, or 2 | R^{A}.1 | Y.2 | V.5 |
| E.196 | (a.4) | 0, 1, or 2 | R^{A}.1 | Y.2 | V.5 |
| E.197 | (a.5) | 0, 1, or 2 | R^{A}.1 | Y.2 | V.5 |
| E.198 | (a.6) | 0, 1, or 2 | R^{A}.1 | Y.2 | V.5 |
| E.199 | (a.1) | 0 or 1 | R^{A}.2 | Y.2 | V.5 |
| E.200 | (a.2) | 0 or 1 | R^{A}.2 | Y.2 | V.5 |
| E.201 | (a.3) | 0 or 1 | R^{A}.2 | Y.2 | V.5 |
| E.202 | (a.4) | 0 or 1 | R^{A}.2 | Y.2 | V.5 |
| E.203 | (a.5) | 0 or 1 | R^{A}.2 | Y.2 | V.5 |
| E.204 | (a.6) | 0 or 1 | R^{A}.2 | Y.2 | V.5 |
| E.205 | (a.1) | 0 or 1 | R^{A}.3 | Y.2 | V.5 |
| E.206 | (a.2) | 0 or 1 | R^{A}.3 | Y.2 | V.5 |
| E.207 | (a.3) | 0 or 1 | R^{A}.3 | Y.2 | V.5 |
| E.208 | (a.4) | 0 or 1 | R^{A}.3 | Y.2 | V.5 |
| E.209 | (a.5) | 0 or 1 | R^{A}.3 | Y.2 | V.5 |
| E.210 | (a.6) | 0 or 1 | R^{A}.3 | Y.2 | V.5 |
| E.211 | (a.1) | 0 | — | Y.2 | V.5 |
| E.212 | (a.2) | 0 | — | Y.2 | V.5 |
| E.213 | (a.3) | 0 | — | Y.2 | V.5 |
| E.214 | (a.4) | 0 | — | Y.2 | V.5 |
| E.215 | (a.5) | 0 | — | Y.2 | V.5 |
| E.216 | (a.6) | 0 | — | Y.2 | V.5 |
| E.217 | (a.1) | 0, 1, or 2 | R^{A}.1 | Y.2 | V.6 |
| E.218 | (a.2) | 0, 1, or 2 | R^{A}.1 | Y.2 | V.6 |
| E.219 | (a.3) | 0, 1, or 2 | R^{A}.1 | Y.2 | V.6 |
| E.220 | (a.4) | 0, 1, or 2 | R^{A}.1 | Y.2 | V.6 |
| E.221 | (a.5) | 0, 1, or 2 | R^{A}.1 | Y.2 | V.6 |
| E.222 | (a.6) | 0, 1, or 2 | R^{A}.1 | Y.2 | V.6 |
| E.223 | (a.1) | 0 or 1 | R^{A}.2 | Y.2 | V.6 |
| E.224 | (a.2) | 0 or 1 | R^{A}.2 | Y.2 | V.6 |
| E.225 | (a.3) | 0 or 1 | R^{A}.2 | Y.2 | V.6 |
| E.226 | (a.4) | 0 or 1 | R^{A}.2 | Y.2 | V.6 |
| E.227 | (a.5) | 0 or 1 | R^{A}.2 | Y.2 | V.6 |
| E.228 | (a.6) | 0 or 1 | R^{A}.2 | Y.2 | V.6 |
| E.229 | (a.1) | 0 or 1 | R^{A}.3 | Y.2 | V.6 |
| E.230 | (a.2) | 0 or 1 | R^{A}.3 | Y.2 | V.6 |
| E.231 | (a.3) | 0 or 1 | R^{A}.3 | Y.2 | V.6 |
| E.232 | (a.4) | 0 or 1 | R^{A}.3 | Y.2 | V.6 |
| E.233 | (a.5) | 0 or 1 | R^{A}.3 | Y.2 | V.6 |
| E.234 | (a.6) | 0 or 1 | R^{A}.3 | Y.2 | V.6 |
| E.235 | (a.1) | 0 | — | Y.2 | V.6 |
| E.236 | (a.2) | 0 | — | Y.2 | V.6 |
| E.237 | (a.3) | 0 | — | Y.2 | V.6 |
| E.238 | (a.4) | 0 | — | Y.2 | V.6 |
| E.239 | (a.5) | 0 | — | Y.2 | V.6 |
| E.240 | (a.6) | 0 | — | Y.2 | V.6 |

In one embodiment, the present invention relates to compounds of the formulae I.A1 to I.Q2 below, and to their use for controlling unwanted vegetation, wherein the variables R^{A}, R³ and R⁴ are as defined or preferably defined herein.

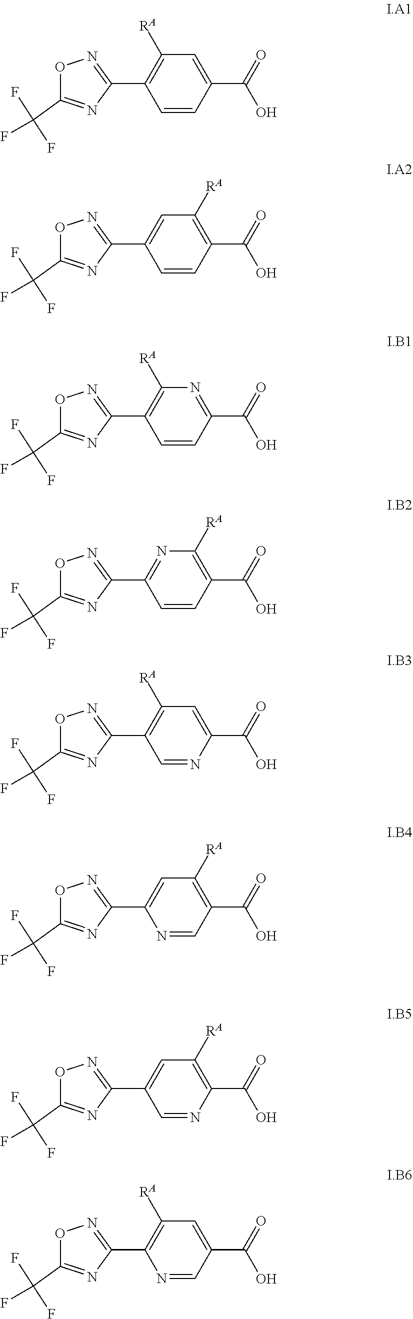

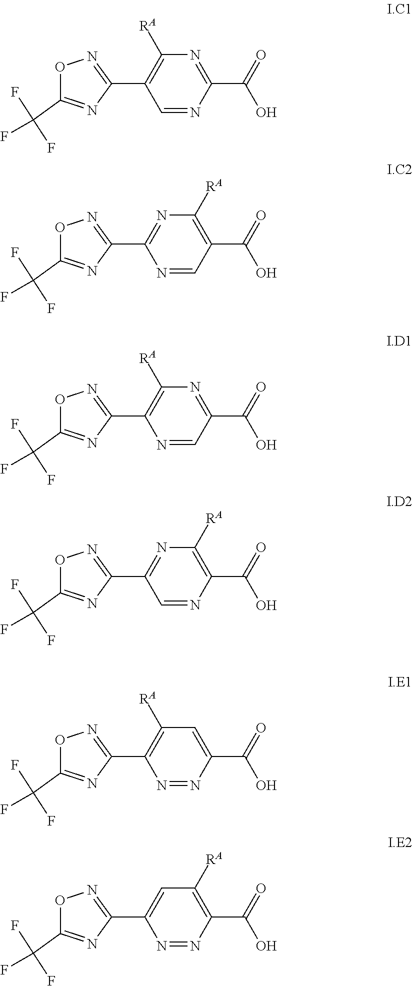

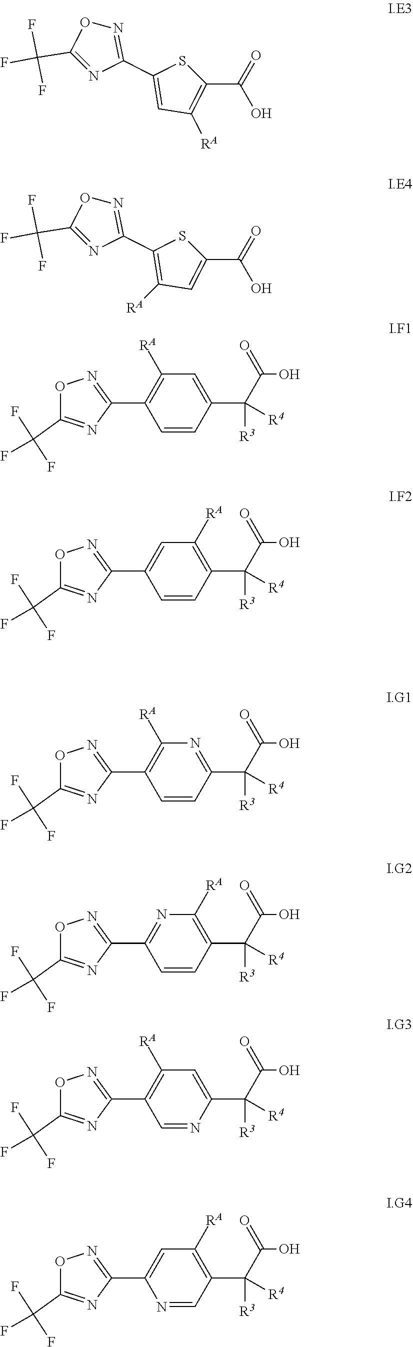

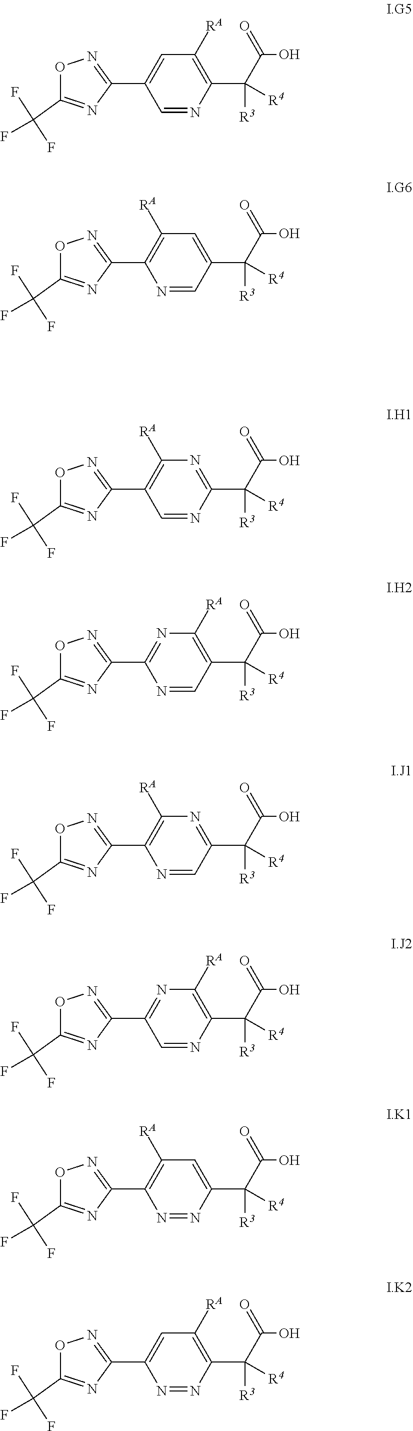

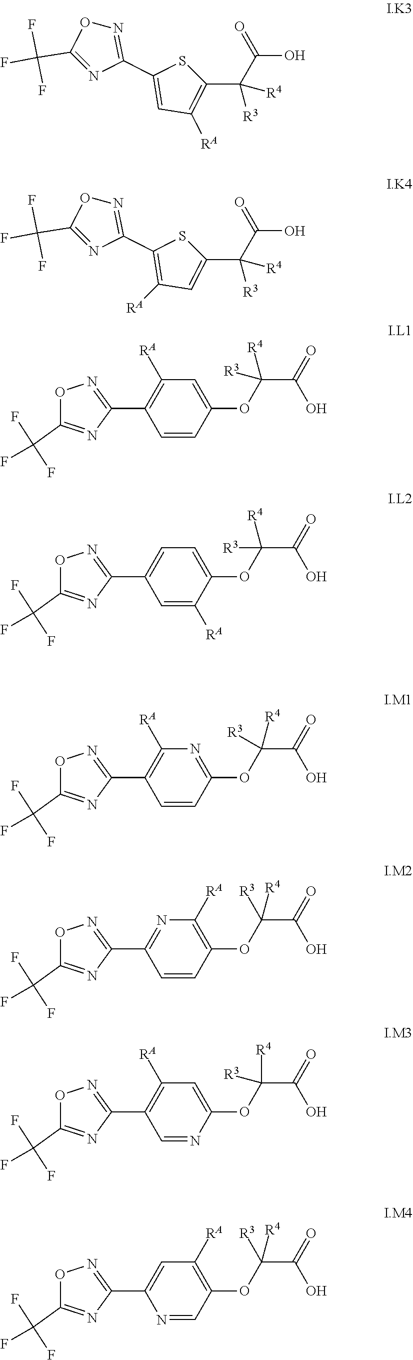

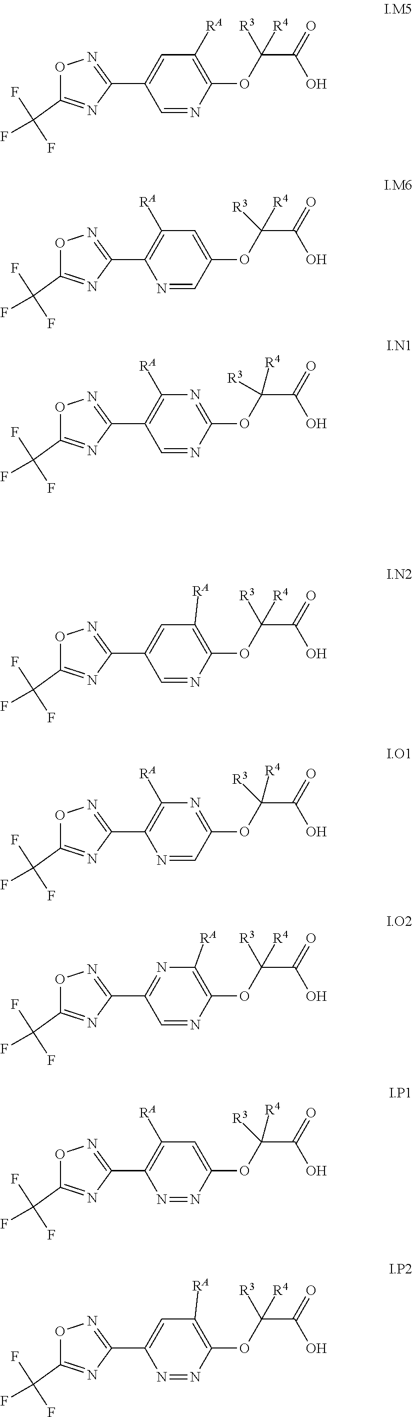

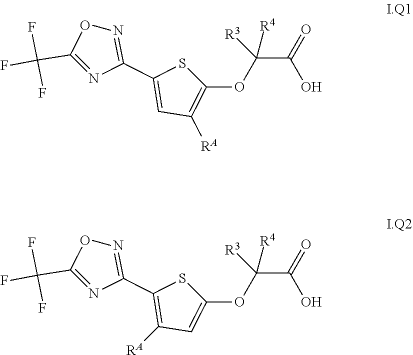

Preference is given to the compounds I compiled in Tables 1 to 48 below:

Table 1: Compounds of the formula I.A1, in which R^{A} for each compound corresponds to one row of Table A (compounds I.A1-A-1 to I.A1-A-11). Accordingly, a compound of formula I, wherein A is subformula (a.1), n is 1, and wherein R^{A} is fluorine, which is attached to the phenyl ring in ortho-position to the oxadiazole ring, is denominated I.A1-A-2.

Table 2: Compounds of the formula I.A2, in which R^{A} for each compound corresponds to one row of Table A (compounds I.A2-A-1 to I.A2-A-11). Accordingly, a compound of formula I, wherein A is subformula (a.1), n is 1, and wherein R^{A} is fluorine, which is attached to the phenyl ring in meta-position to the oxadiazole ring, is denominated I.A2-A-2.

Table 3: Compounds of the formula I.B1, in which R^{A} for each compound corresponds to one row of Table A (compounds I-A-1 to I-A-11).

Table 4: Compounds of the formula I.B2, in which R^{A} for each compound corresponds to one row of Table A (compounds I.E2-A-1 to I.E2-A-11).

Table 5: Compounds of the formula I.B3, in which R^{A} for each compound corresponds to one row of Table A (compounds I.E3-A-1 to I.E3-A-11).

Table 6: Compounds of the formula I.B4, in which R^{A} for each compound corresponds to one row of Table A (compounds I.E4-A-1 to I.E4-A-11).

Table 7: Compounds of the formula I.B5, in which R^{A} for each compound corresponds to one row of Table A(compounds I.E5-A-1 to I.E5-A-11).

Table 8: Compounds of the formula I.B6, in which R^{A} for each compound corresponds to one row of Table A (compounds I.E6-A-1 to I.E6-A-11).

Table 9: Compounds of the formula I.C1, in which R^{A} for each compound corresponds to one row of Table A (compounds I.C1-A-1 to I.C1-A-11).

Table 10: Compounds of the formula I.C2, in which R^{A} for each compound corresponds to one row of Table A (compounds I.C2-A-1 to I.C2-A-11).

Table 11: Compounds of the formula I.D1, in which R^{A} for each compound corresponds to one row of Table A (compounds I.D1-A-1 to I.D1-A-11).

Table 12: Compounds of the formula I.D2, in which R^{A} for each compound corresponds to one row of Table A (compounds I.D2-A-1 to I.D2-A-11).

Table 13: Compounds of the formula I.E1, in which R^{A} for each compound corresponds to one row of Table A (compounds I.E1-A-1 to I.E1-A-11).

Table 14: Compounds of the formula I.E2, in which R^{A} for each compound corresponds to one row of Table A (compounds I.E2-A-1 to I.E2-A-11).

Table 15: Compounds of the formula I.E3, in which R^{A} for each compound corresponds to one row of Table A (compounds I.E3-A-1 to I.E3-A-11).

Table 16: Compounds of the formula I.E4, in which R^{A} for each compound corresponds to one row of Table A (compounds I.E4-A-1 to I.E4-A-11).

Table 17: Compounds of the formulae I.F1, in which R^{A}, R³ and R⁴ for each compound corresponds to one row of Table B (compounds I.F1-B-1 to I.F1-B-99).

Table 18: Compounds of the formulae I.F2, in which R^{A}, R³ and R⁴ for each compound corresponds to one row of Table B (compounds I.F2-B-1 to I.F2-B-99).

Table 19: Compounds of the formulae I.G1, in which R^{A}, R³ and R⁴ for each compound corresponds to one row of Table B (compounds I.G1-B-1 to I.G1-B-99).

Table 20: Compounds of the formulae I.G2, in which R^{A}, R³ and R⁴ for each compound corresponds to one row of Table B (compounds I.G2-B-1 to I.G2-B-99).

Table 21: Compounds of the formulae I.G3, in which R^{A}, R³ and R⁴ for each compound corresponds to one row of Table B (compounds I.G3-B-1 to I.G3-B-99).

Table 22: Compounds of the formulae I.G4, in which R^{A}, R³ and R⁴ for each compound corresponds to one row of Table B (compounds I.G4-B-1 to I.G4-B-99).

Table 23: Compounds of the formulae I.G5, in which R^{A}, R³ and R⁴ for each compound corresponds to one row of Table B (compounds I.G5-B-1 to I.G5-B-99).

Table 24: Compounds of the formulae I.G6, in which R^{A}, R³ and R⁴ for each compound corresponds to one row of Table B (compounds I.G6-B-1 to I.G6-B-99).

Table 25: Compounds of the formulae I.H1, in which R^{A}, R³ and R⁴ for each compound corresponds to one row of Table B (compounds I.H1-B-1 to I.H1-B-99).

Table 26: Compounds of the formulae I.H2, in which R^{A}, R³ and R⁴ for each compound corresponds to one row of Table B (compounds I.H2-B-1 to I.H2-B-99).

Table 27: Compounds of the formulae I.J1, in which R^{A}, R³ and R⁴ for each compound corresponds to one row of Table B (compounds I.J1-B-1 to I.J1-B-99).

Table 28: Compounds of the formulae I.J2, in which R^{A}, R³ and R⁴ for each compound corresponds to one row of Table B (compounds I.J2-B-1 to I.J2-B-99).

Table 29: Compounds of the formulae I.K1, in which R^{A}, R³ and R⁴ for each compound corresponds to one row of Table B (compounds I.K1-B-1 to I.K1-B-99).

Table 30: Compounds of the formulae I.K2, in which R^{A}, R³ and R⁴ for each compound corresponds to one row of Table B (compounds I.K2-B-1 to I.K2-B-99).

Table 31: Compounds of the formulae I.K3, in which R^{A}, R³ and R⁴ for each compound corresponds to one row of Table B (compounds I.K3-B-1 to I.K3-B-99).

Table 32: Compounds of the formulae I.K4, in which R^{A}, R³ and R⁴ for each compound corresponds to one row of Table B (compounds I.K4-B-1 to I.K4-B-99).

Table 33: Compounds of the formulae I.L1, in which R^{A}, R³ and R⁴ for each compound corresponds to one row of Table B (compounds I.L1-B-1 to I.L1-B-99).

Table 34: Compounds of the formulae I.L2, in which R^{A}, R³ and R⁴ for each compound corresponds to one row of Table B (compounds I.L2-B-1 to I.L2-B-99).

Table 35: Compounds of the formulae I.M1, in which R^{A}, R³ and R⁴ for each compound corresponds to one row of Table B (compounds I.M1-B-1 to I.M1-B-99).

Table 36: Compounds of the formulae I.M2, in which R^{A}, R³ and R⁴ for each compound corresponds to one row of Table B (compounds I.M2-B-1 to I.M2-B-99).

Table 37: Compounds of the formulae I.M3, in which R^{A}, R³ and R⁴ for each compound corresponds to one row of Table B (compounds I.M3-B-1 to I.M3-B-99).

Table 38: Compounds of the formulae I.M4, in which R^{A}, R³ and R⁴ for each compound corresponds to one row of Table B (compounds I.M4-B-1 to I.M4-B-99).

Table 39: Compounds of the formulae I.M5, in which R^{A}, R³ and R⁴ for each compound corresponds to one row of Table B (compounds I.M5-B3-1 to I.M5-B3-99).

Table 40: Compounds of the formulae I.M6, in which R^{A}, R³ and R⁴ for each compound corresponds to one row of Table B (compounds I.M6-B3-1 to I.M6-B3-99).

Table 41: Compounds of the formulae I.N1, in which R^{A}, R³ and R⁴ for each compound corresponds to one row of Table B (compounds I.N1-B3-1 to I.N1-B-99).

Table 42: Compounds of the formulae I.N2, in which R^{A}, R³ and R⁴ for each compound corresponds to one row of Table B (compounds I.N2-B3-1 to I.N2-B3-99).

Table 43: Compounds of the formulae I.O1, in which R^{A}, R³ and R⁴ for each compound corresponds to one row of Table B (compounds I.O1-B3-1 to I.O1-B3-99).

Table 44: Compounds of the formulae I.O2, in which R^{A}, R³ and R⁴ for each compound corresponds to one row of Table B (compounds I.O2-B3-1 to I.O2-B3-99).

Table 45: Compounds of the formulae I.P1, in which R^{A}, R³ and R⁴ for each compound corresponds to one row of Table B (compounds I.P1-B3-1 to I.P1-B-99).

Table 46: Compounds of the formulae I.P2, in which R^{A}, R³ and R⁴ for each compound corresponds to one row of Table B (compounds I.P2-B3-1 to I.P2-B3-99).

Table 47: Compounds of the formulae I.P3, in which R^{A}, R³ and R⁴ for each compound corresponds to one row of Table B (compounds I.P3-B3-1 to I.P3-B3-99).

Table 48: Compounds of the formulae I.P4, in which R^{A}, R³ and R⁴ for each compound corresponds to one row of Table B (compounds I.P4-B3-1 to I.P4-B3-99).

TABLE A

| No. | R^{A} |
|---|---|
| A-1 | H |
| A-2 | F |
| A-3 | Cl |
| A-4 | CH₃ |
| A-5 | CH₂F |
| A-6 | CHF₂ |
| A-7 | CF₃ |
| A-8 | —O—CH₃ |
| A-9 | —O—CH₂F |
| A-10 | —O—CHF₂ |
| A-11 | —O—CF₃ |

TABLE B
(the term “Cyp” in table B means that radicals
R³ and R⁴ together with the carbon atom to which they
are bound form a cyclopropyl ring; the term “(═O)” means
that R³ and R⁴ together stand for an oxo group)

| No. | R^{A} | R³, R⁴ |
|---|---|---|
| B-1 | H | H, H |
| B-2 | F | H, H |
| B-3 | Cl | H, H |
| B-4 | CH₃ | H, H |
| B-5 | CH₂F | H, H |
| B-6 | CHF₂ | H, H |
| B-7 | CF₃ | H, H |
| B-8 | —O—CH₃ | H, H |
| B-9 | —O—CH₂F | H, H |
| B-10 | —O—CHF₂ | H, H |
| B-11 | —O—CF₃ | H, H |
| B-12 | H | F, F |
| B-13 | F | F, F |
| B-14 | Cl | F, F |
| B-15 | CH₃ | F, F |
| B-16 | CH₂F | F, F |
| B-17 | CHF₂ | F, F |
| B-18 | CF₃ | F, F |
| B-19 | —O—CH₃ | F, F |
| B-20 | —O—CH₂F | F, F |
| B-21 | —O—CHF₂ | F, F |
| B-22 | —O—CF₃ | F, F |
| B-23 | H | H, CH₃ |
| B-24 | F | H, CH₃ |
| B-25 | Cl | H, CH₃ |
| B-26 | CH₃ | H, CH₃ |
| B-27 | CH₂F | H, CH₃ |
| B-28 | CHF₂ | H, CH₃ |
| B-29 | CF₃ | H, CH₃ |
| B-30 | —O—CH₃ | H, CH₃ |
| B-31 | —O—CH₂F | H, CH₃ |
| B-32 | —O—CHF₂ | H, CH₃ |
| B-33 | —O—CF₃ | H, CH₃ |
| B-34 | H | CH₃, CH₃ |
| B-35 | F | CH₃, CH₃ |
| B-36 | Cl | CH₃, CH₃ |
| B-37 | CH₃ | CH₃, CH₃ |
| B-38 | CH₂F | CH₃, CH₃ |
| B-39 | CHF₂ | CH₃, CH₃ |
| B-40 | CF₃ | CH₃, CH₃ |
| B-41 | —O—CH₃ | CH₃, CH₃ |
| B-42 | —O—CH₂F | CH₃, CH₃ |
| B-43 | —O—CHF₂ | CH₃, CH₃ |
| B-44 | —O—CF₃ | CH₃, CH₃ |
| B-45 | H | H, OH |
| B-46 | F | H, OH |
| B-47 | Cl | H, OH |
| B-48 | CH₃ | H, OH |
| B-49 | CH₂F | H, OH |
| B-50 | CHF₂ | H, OH |
| B-51 | CF₃ | H, OH |
| B-52 | —O—CH₃ | H, OH |
| B-53 | —O—CH₂F | H, OH |
| B-54 | —O—CHF₂ | H, OH |
| B-55 | —O—CF₃ | H, OH |
| B-56 | H | H, —O—CH₃ |
| B-57 | F | H, —O—CH₃ |
| B-58 | Cl | H, —O—CH₃ |
| B-59 | CH₃ | H, —O—CH₃ |
| B-60 | CH₂F | H, —O—CH₃ |
| B-61 | CHF₂ | H, —O—CH₃ |
| B-62 | CF₃ | H, —O—CH₃ |
| B-63 | —O—CH₃ | H, —O—CH₃ |
| B-64 | —O—CH₂F | H, —O—CH₃ |
| B-65 | —O—CHF₂ | H, —O—CH₃ |
| B-66 | —O—CF₃ | H, —O—CH₃ |
| B-67 | H | (═O) |
| B-68 | F | (═O) |
| B-69 | Cl | (═O) |
| B-70 | CH₃ | (═O) |
| B-71 | CH₂F | (═O) |
| B-72 | CHF₂ | (═O) |
| B-73 | CF₃ | (═O) |
| B-74 | —O—CH₃ | (═O) |
| B-75 | —O—CH₂F | (═O) |
| B-76 | —O—CHF₂ | (═O) |
| B-77 | —O—CF₃ | (═O) |
| B-78 | H | Cyp |
| B-79 | F | Cyp |
| B-80 | Cl | Cyp |
| B-81 | CH₃ | Cyp |
| B-82 | CH₂F | Cyp |
| B-83 | CHF₂ | Cyp |
| B-84 | CF₃ | Cyp |
| B-85 | —O—CH₃ | Cyp |
| B-86 | —O—CH₂F | Cyp |
| B-87 | —O—CHF₂ | Cyp |
| B-88 | —O—CF₃ | Cyp |
| B-89 | H | F, CH₃ |
| B-90 | F | F, CH₃ |
| B-91 | Cl | F, CH₃ |
| B-92 | CH₃ | F, CH₃ |
| B-93 | CH₂F | F, CH₃ |
| B-94 | CHF₂ | F, CH₃ |
| B-95 | CF₃ | F, CH₃ |
| B-96 | —O—CH₃ | F, CH₃ |
| B-97 | —O—CH₂F | F, CH₃ |
| B-98 | —O—CHF₂ | F, CH₃ |
| B-99 | —O—CF₃ | F, CH₃ |

The compounds of formula I can be prepared according to methods or in analogy to methods that are described in the prior art. The synthesis procedures in the context of the preparation of compounds of formula I that are disclosed in the references cited below are incorporated herein as a basis for an enabling disclosure of the present invention. The syntheses takes advantage of starting materials that are either commercially available or may be prepared according to conventional procedures starting from readily available compounds.

Compounds of formula I, wherein Y is a direct bond and V is absent, are either commercially available or can be prepared from nitrile compounds of formula II,

N≡C-A-COOH II

wherein the variable A is as defined or preferably defined herein for compounds of formula I, by treatment with hydroxylamine or its hydrochloride salt, in the presence of a base, preferably triethylamine, sodium hydroxide or sodium methylate, in a suitable solvent, such as methanol, ethanol or water, or a mixture of these solvents, at a temperature between 0° C. and 100° C., to obtain amidoxime compounds, which are then further treated with an activated derivative of trifluoroacetic acid, for example trifluoroacetic acid anhydride or trifluoroacetic chloride to give oxadiazoles of formula I. For related examples see Kitamura, S. et al. in Chem. Pharm. Bull. 2001, 49, 268, WO 2015/185485, or WO 2017/174158. Compounds of formula II are either commercially available or may be prepared using standard procedures known to a person skilled in the art from readily available starting materials. Compounds of formula I, wherein A is a thiophenyl group, Y is a direct bond, and V is absent, can be prepared as described by Goddard et al. in Journal of Heterocyclic Chemistry 1991, 28(1), 17-28.

Compounds of formula I, wherein Y is a direct bond and V is —C(═O)—, are either commercially available or can be prepared in accordance with procedures described in WO 2018/065414, or WO 2020/002331.

Compounds of formula I, wherein Y is a direct bond and V is —CR³R⁴—, are either commercially available or can be prepared in accordance with procedures described in WO 2017/076742, WO 2013/008162, WO 2019/097054, or WO 2019/022061.

Compounds of formula I, wherein Y is a —O— or —S— and V is —CR³R⁴—, can be prepared in accordance with procedures described in WO 2018/234139, WO 2014/100730; Organic Letters 2017, 19(3), 568-571; Organic Letters 2016, 18(15), 3754-3757; Journal of Fluorine Chemistry 2017, 203, 130-135; US 20150023913.

The compounds I and the compositions thereof, respectively, are suitable as fungicides effective against a broad spectrum of phytopathogenic fungi, including soil-borne fungi, in particular from the classes of Plasmodiophoromycetes, Peronosporomycetes (syn. Oomycetes), Chytridiomycetes, Zygomycetes, Ascomycetes, Basidiomycetes, and Deuteromycetes (syn. Fungi imperfecti). They can be used in crop protection as foliar fungicides, fungicides for seed dressing, and soil fungicides.

The compounds I and the compositions thereof are preferably useful in the control of phytopathogenic fungi on various cultivated plants, such as cereals, e.g. wheat, rye, barley, triticale, oats, or rice; beet, fruits, leguminous plants, oil plants, cucurbits, fiber plants, citrus fruits, vegetables, lauraceous plants, energy and raw material plants, corn; tobacco; nuts; coffee; tea; bananas; vines (table grapes and grape juice grape vines); natural rubber plants; or ornamental and forestry plants; on the plant propagation material, such as seeds; and on the crop material of these plants.

According to the invention all of the above cultivated plants are understood to comprise all species, subspecies, variants and/or hybrids which belong to the respective cultivated plants. Corn is also known as Indian corn or maize (Zea mays) which comprises all kinds of corn such as field corn and sweet corn.

The term “cultivated plants” is to be understood as including plants which have been modified by mutagenesis or genetic engineering to provide a new trait to a plant or to modify an already present trait.

The compounds I and compositions thereof, respectively, are particularly suitable for controlling the following causal agents of plant diseases: Phakopsora pachyrhizi and P. meibomiae on soybeans and/or against Puccinia triticina, P. striiformis, P. hordei, P. graminis or P. recondita on wheat, barley or rye; P. coronata e.g. on oats, P. sorghi und P. polysora on corn; Puccinia spp. on other crops, e.g. P. heliathi on sunflower, P. arachidis on peanuts; Uromyces spp. on pulses and other crops crops, e.g. Uromyces viciae-fabae, Uromyces vigniae, Uromyces pisi, U. ciceris-arietini, U. betae syn U. beticola; molds on specialty crops, soybean, oil seed rape and sunflowers (e.g. Botrytis cinerea on strawberries and vines, Sclerotinia sclerotiorum, S. minor and S. rolfsii on oil seed rape, sunflowers and soybean); Fusarium diseases on cereals (e.g. Fusarium culmorum and F. graminearum on wheat); downy mildews on specialty crops (e.g. Peronospora parasitica on vines, Phytophthora infestans on potatoes); powdery mildews on specialty crops and cereals (e.g. Uncinula necator on vines, Erysiphe spp. on various specialty crops, Blumeria graminis on cereals); and leaf spots on cereals, soybean and corn (e.g. Septoria tritici and S. nodorum on cereals, S. glycines on soybean, Cercospora spp. on corn and soybean).

Most preferably the compounds I and compositions thereof, respectively, are particularly suitable for controlling Phakopsora pachyrhizi and P. meibomiae on soybeans

The compounds I and compositions thereof, respectively, are also suitable for controlling harmful microorganisms in the protection of stored products or harvest, and in the protection of materials.

The compounds I are employed as such or in form of compositions by treating the fungi, the plants, plant propagation materials, such as seeds; soil, surfaces, materials, or rooms to be protected from fungal attack with a fungicidally effective amount of the active substances. The application can be carried out both before and after the infection of the plants, plant propagation materials, such as seeds; soil, surfaces, materials or rooms by the fungi.

Plant propagation materials may be treated with compounds I as such or a composition comprising at least one compound I prophylactically either at or before planting or transplanting.

The invention also relates to agrochemical compositions comprising an auxiliary and at least one compound I.

An agrochemical composition comprises a fungicidally effective amount of a compound I. The term “fungicidally effective amount” denotes an amount of the composition or of the compounds I, which is sufficient for controlling harmful fungi on cultivated plants or in the protection of stored products or harvest or of materials and which does not result in a substantial damage to the treated plants, the treated stored products or harvest, or to the treated materials. Such an amount can vary in a broad range and is dependent on various factors, such as the fungal species to be controlled, the treated cultivated plant, stored product, harvest or material, the climatic conditions and the specific compound I used.

The user applies the agrochemical composition usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

The compounds I, their N-oxides and salts can be converted into customary types of agrochemical compositions, e.g. solutions, emulsions, suspensions, dusts, powders, pastes, granules, pressings, capsules, and mixtures thereof. Examples for composition types (see also “Catalogue of pesticide formulation types and international coding system”, Technical Monograph No. 2, 6^{th} Ed. May 2008, CropLife International) are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials, such as seeds (e.g. GF). The compositions are prepared in a known manner, such as described by Mollet and Grubemann, Formulation technology, Wiley VCH, Weinheim, 2001; or by Knowles, New developments in crop protection product formulation, Agrow Reports DS243, T&F Informa, London, 2005.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers, and binders.

The agrochemical compositions generally comprise between 0.01 and 95%, preferably between 0.1 and 90%, more preferably between 1 and 70%, and in particular between 10 and 60%, by weight of active substance (e.g. at least one compound I). Further, the agrochemical compositions generally comprise between 5 and 99.9%, preferably between 10 and 99.9%, more preferably between 30 and 99%, and in particular between 40 and 90%, by weight of at least one auxiliary.

When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, and in particular from 0.1 to 0.75 kg per ha.

In treatment of plant propagation materials, such as seeds, e.g. by dusting, coating, or drenching, amounts of active substance of generally from 0.1 to 1000 g, preferably from 1 to 1000 g, more preferably from 1 to 100 g and most preferably from 5 to 100 g, per 100 kg of plant propagation material (preferably seeds) are required.

Various types of oils, wetters, adjuvants, fertilizers, or micronutrients, and further pesticides (e.g. fungicides, growth regulators, herbicides, insecticides, safeners) may be added to the compounds I or the compositions thereof as premix, or, not until immediately prior to use (tank mix). These agents can be admixed with the compositions according to the invention in a weight ratio of 1:100 to 100:1, preferably 1:10 to 10:1.

Mixing the compounds I or the compositions comprising them in the use form as fungicides with other fungicides results in many cases in an expansion of the fungicidal spectrum of activity or in a prevention of fungicide resistance development. Furthermore, in many cases, synergistic effects are obtained (synergistic mixtures).

The following list of pesticides 1l, in conjunction with which the compounds I can be used, is intended to illustrate the possible combinations but does not limit them:

A) Respiration Inhibitors
Inhibitors of complex Ill at Qₒ site: azoxystrobin (A.1.1), coumethoxystrobin (A.1.2), coumoxystrobin (A.1.3), dimoxystrobin (A.1.4), enestroburin (A.1.5), fenaminstrobin (A.1.6), fenoxystrobin/flufenoxystrobin (A.1.7), fluoxastrobin (A.1.8), kresoxim-methyl (A.1.9), mandestrobin (A.1.10), metominostrobin (A.1.11), orysastrobin (A.1.12), picoxystrobin (A.1.13), pyraclostrobin (A.1.14), pyrametostrobin (A.1.15), pyraoxystrobin (A.1.16), trifloxystrobin (A.1.17), 2-(2-(3-(2,6-dichlorophenyl)-1-methyl-allylideneaminooxymethyl)-phenyl)-2-methoxyimino-N-methyl-acetamide (A.1.18), pyribencarb (A.1.19), triclopyricarb/chlorodincarb (A.1.20), famoxadone (A.1.21), fenamidone (A.1.21a), methyl-N-[2-[(1,4-dimethyl-5-phenyl-pyrazol-3-yl)oxylmethyl]phenyl]-N-methoxy-carbamate (A.1.22), metyltetrapole (A.1.25), (Z,2E)-5-[1-(2,4-dichlorophenyl)pyrazol-3-yl]-oxy-2-methoxyimino-N,3-dimethyl-pent-3-enamide (A.1.34), (Z,2E)-5-[1-(4-chlorophenyl)pyrazol-3-yl]oxy-2-methoxyimino-N,3-dimethyl-pent-3-enamide (A.1.35), pyriminostrobin (A.1.36), bifujunzhi (A.1.37), 2-(ortho-((2,5-dimethylphenyl-oxymethylen)phenyl)-3-methoxy-acrylic acid methylester (A.1.38);
inhibitors of complex Ill at Qᵢ site: cyazofamid (A.2.1), amisulbrom (A.2.2), [(6S,7R,8R)-8-benzyl-3-[(3-hydroxy-4-methoxy-pyridine-2-carbonyl)amino]-6-methyl-4,9-dioxo-1,5-dioxonan-7-yl] 2-methylpropanoate (A.2.3), fenpicoxamid (A.2.4), florylpicoxamid (A.2.5), metarylpicoxamid (A.2.6);
inhibitors of complex II: benodanil (A.3.1), benzovindiflupyr (A.3.2), bixafen (A.3.3), boscalid (A.3.4), carboxin (A.3.5), fenfuram (A.3.6), fluopyram (A.3.7), flutolanil (A.3.8), fluxapyroxad (A.3.9), furametpyr (A.3.10), isofetamid (A.3.11), isopyrazam (A.3.12), mepronil (A.3.13), oxycarboxin (A.3.14), penflufen (A.3.15), penthiopyrad (A.3.16), pydiflumetofen (A.3.17), pyraziflumid (A.3.18), sedaxane (A.3.19), tecloftalam (A.3.20), thifluzamide (A.3.21), inpyrfluxam (A.3.22), pyrapropoyne (A.3.23), cyclobutrifluram (A.3.24), fluindapyr (A.3.28), methyl (E)-2-[2-[(5-cyano-2-methyl-phenoxy)methyl]phenyl]-3-methoxy-prop-2-enoate (A.3.30), isoflucypram (A.3.31), 2-(difluoromethyl)-N-(1,1,3-trimethyl-indan-4-yl)pyridine-3-carboxamide (A.3.32), 2-(difluoromethyl)-N-[(3R)-1,1,3-trimethylindan-4-yl]pyridine-3-carboxamide (A.3.33), 2-(difluoromethyl)-N-(3-ethyl-1,1-dimethyl-indan-4-yl)pyridine-3-carboxamide (A.3.34), 2-(difluoromethyl)-N-[(3R)-3-ethyl-1,1-dimethyl-indan-4-yl]pyridine-3-carboxamide (A.3.35), 2-(difluoromethyl)-N-(1,1-dimethyl-3-propyl-indan-4-yl)pyridine-3-carboxamide (A.3.36), 2-(difluoromethyl)-N-[(3R)-1,1-dimethyl-3-propyl-indan-4-yl]pyridine-3-carboxamide (A.3.37), 2-(difluoromethyl)-N-(3-isobutyl-1,1-dimethyl-indan-4-yl)pyridine-3-carboxamide (A.3.38), 2-(difluoromethyl)-N-[(3R)-3-isobutyl-1,1-dimethyl-indan-4-yl]pyridine-3-carboxamide (A.3.39);
other respiration inhibitors: diflumetorim (A.4.1); nitrophenyl derivates: binapacryl (A.4.2), dinobuton (A.4.3), dinocap (A.4.4), fluazinam (A.4.5), meptyldinocap (A.4.6), ferimzone (A.4.7); organometal compounds: fentin salts, e.g. fentin-acetate (A.4.8), fentin chloride (A.4.9) or fentin hydroxide (A.4.10); ametoctradin (A.4.11); silthiofam (A.4.12);

B) Sterol Biosynthesis Inhibitors (SBI Fungicides)
C14 demethylase inhibitors: triazoles: azaconazole (B.1.1), bitertanol (B.1.2), bromuconazole (B.1.3), cyproconazole (B.1.4), difenoconazole (B.1.5), diniconazole (B.1.6), diniconazole-M (B.1.7), epoxiconazole (B.1.8), fenbuconazole (B.1.9), fluquinconazole (B.1.10), flusilazole (B.1.11), flutriafol (B.1.12), hexaconazole (B.1.13), imibenconazole (B.1.14), ipconazole (B.1.15), metconazole (B.1.17), myclobutanil (B.1.18), oxpoconazole (B.1.19), paclobutrazole (B.1.20), penconazole (B.1.21), propiconazole (B.1.22), prothioconazole (B.1.23), simeconazole (B.1.24), tebuconazole (B.1.25), tetraconazole (B.1.26), triadimefon (B.1.27), triadimenol (B.1.28), triticonazole (B.1.29), uniconazole (B.1.30), 2-(2,4-difluorophenyl)-1,1-difluoro-3-(tetrazol-1-yl)-1-[5-[4-(2,2,2-trifluoroethoxy)phenyl]-2-pyridyl]propan-2-ol (B.1.31), 2-(2,4-difluorophenyl)-1,1-difluoro-3-(tetrazol-1-yl)-1-[5-[4-(trifluoromethoxy)phenyl]-2-pyridyl]propan-2-ol (B.1.32), ipfentrifluconazole (B.1.37), mefentrifluconazole (B.1.38), 2-(chloromethyl)-2-methyl-5-(p-tolylmethyl)-1-(1,2,4-triazol-1-ylmethyl)cyclopentanol (B.1.43); imidazoles: imazalil (B.1.44), pefurazoate (B.1.45), prochloraz (B.1.46), triflumizol (B.1.47); pyrimidines, pyridines, piperazines: fenarimol (B.1.49), pyrifenox (B.1.50), triforine (B.1.51), [3-(4-chloro-2-fluoro-phenyl)-5-(2,4-difluorophenyl)isoxazol-4-yl]-(3-pyridyl)methanol (B.1.52), 4-[[6-[2-(2,4-difluorophenyl)-1,1-difluoro-2-hydroxy-3-(1,2,4-triazol-1-yl)propyl]-3-pyridyl]oxy]-benzo¬nitrile (B.1.53) 2-[6-(4-bromophenoxy)-2-(trifluoromethyl)-3-pyridyl]-1-(1,2,4-triazol-1 yl)propan-2-ol (B.1.54), 2-[6-(4-chlorophenoxy)-2-(trifluoromethyl)-3-pyridyl]-1-(1,2,4-triazol-1-yl)propan-2-ol (B.1.55), (2R)-2-[4-(4-chlorophenoxy)-2-(trifluoromethyl)phenyl]-1-(1,2,4-triazol-1-yl)propan-2-ol (B.1.56), (2S)-2-[4-(4-chlorophenoxy)-2-(trifluoromethyl)phenyl]-1-(1,2,4-triazol-1-yl)propan-2-ol (B.1.57);
Delta14-reductase inhibitors: aldimorph (B.2.1), dodemorph (B.2.2), dodemorph-acetate (B.2.3), fenpropimorph (B.2.4), tridemorph (B.2.5), fenpropidin (B.2.6), piperalin (B.2.7), spiroxamine (B.2.8);
Inhibitors of 3-keto reductase: fenhexamid (B.3.1);
Other Sterol biosynthesis inhibitors: chlorphenomizole (B.4.1);

C) Nucleic Acid Synthesis Inhibitors
phenylamides or acyl amino acid fungicides: benalaxyl (C.1.1), benalaxyl-M (C.1.2), kiralaxyl (C.1.3), metalaxyl (C.1.4), metalaxyl-M (C.1.5), ofurace (C.1.6), oxadixyl (C.1.7);
other nucleic acid synthesis inhibitors: hymexazole (C.2.1), octhilinone (C.2.2), oxolinic acid (C.2.3), bupirimate (C.2.4), 5-fluorocytosine (C.2.5), 5-fluoro-2-(p-tolylmethoxy)pyrimidin-4-amine (C.2.6), 5-fluoro-2-(4-fluorophenylmethoxy)pyrimidin-4-amine (C.2.7), 5-fluoro-2-(4-chlorophenylmethoxy)pyrimidin-4 amine (C.2.8);

D) Inhibitors of Cell Division and Cytoskeleton
tubulin inhibitors: benomyl (D.1.1), carbendazim (D.1.2), fuberidazole (D1.3), thiabendazole (D.1.4), thiophanate-methyl (D.1.5), pyridachlometyl (D.1.6), N-ethyl-2-[(3-ethynyl-8-methyl-6-quinolyl)oxy]butanamide (D.1.8), N-ethyl-2-[(3-ethynyl-8-methyl-6-quinolyl)oxy]-2-methylsulfanyl-acetamide (D.1.9), 2-[(3-ethynyl-8-methyl-6-quinolyl)oxy]-N-(2-fluoroethyl)butanamide (D.1.10), 2-[(3-ethynyl-8-methyl-6-quinolyl)oxy]-N-(2-fluoroethyl)-2-methoxy-acetamide (D.1.11), 2-[(3-ethynyl-8-methyl-6-quinolyl)oxy]-N-propyl-butanamide (D.1.12), 2-[(3-ethynyl-8-methyl-6-quinolyl)oxy]-2-methoxy-N-propyl-acetamide (D.1.13), 2-[(3-ethynyl-8-methyl-6-quinolyl)oxy]-2-methylsulfanyl-N-propyl-acetamide (D.1.14), 2-[(3-ethynyl-8-methyl-6-quinolyl)oxy]-N-(2-fluoroethyl)-2-methylsulfanyl-acetamide (D.1.15), 4-(2-bromo-4-fluoro-phenyl)-N-(2-chloro-6-fluoro-phenyl)-2,5-dimethyl-pyrazol-3-amine (D.1.16);
other cell division inhibitors: diethofencarb (D.2.1), ethaboxam (D.2.2), pencycuron (D.2.3), fluopicolide (D.2.4), zoxamide (D.2.5), metrafenone (D.2.6), pyriofenone (D.2.7);

E) Inhibitors of Amino Acid and Protein Synthesis
methionine synthesis inhibitors: cyprodinil (E.1.1), mepanipyrim (E.1.2), pyrimethanil (E.1.3);
protein synthesis inhibitors: blasticidin-S (E.2.1), kasugamycin (E.2.2), kasugamycin hydrochloride-hydrate (E.2.3), mildiomycin (E.2.4), streptomycin (E.2.5), oxytetracyclin (E.2.6);

F) Signal Transduction Inhibitors
MAP/histidine kinase inhibitors: fluoroimid (F.1.1), iprodione (F.1.2), procymidone (F.1.3), vinclozolin (F.1.4), fludioxonil (F.1.5);
G protein inhibitors: quinoxyfen (F.2.1);

G) Lipid and Membrane Synthesis Inhibitors
Phospholipid biosynthesis inhibitors: edifenphos (G.1.1), iprobenfos (G.1.2), pyrazophos (G.1.3), isoprothiolane (G.1.4);
lipid peroxidation: dicloran (G.2.1), quintozene (G.2.2), tecnazene (G.2.3), tolclofos-methyl (G.2.4), biphenyl (G.2.5), chloroneb (G.2.6), etridiazole (G.2.7);
phospholipid biosynthesis and cell wall deposition: dimethomorph (G.3.1), flumorph (G.3.2), mandipropamid (G.3.3), pyrimorph (G.3.4), benthiavalicarb (G.3.5), iprovalicarb (G.3.6), valifenalate (G.3.7);
compounds affecting cell membrane permeability and fatty acids: propamocarb (G.4.1);
inhibitors of oxysterol binding protein: oxathiapiprolin (G.5.1), 2-{3-[2-(1-{[3,5-bis(difluoro-methyl-1H-pyrazol-1-yl]acetyl}piperidin-4-yl)-1,3-thiazol-4-yl]-4,5-dihydro-1,2-oxazol-5-yl}phenyl methanesulfonate (G.5.2), 2-{3-[2-(1-{[3,5-bis(difluoromethyl)-1H-pyrazol-1-yl]acetyl}piperidin-4-yl) 1,3-thiazol-4-yl]-4,5-dihydro-1,2-oxazol-5-yl}-3-chlorophenyl methanesulfonate (G.5.3), 4-[1-[2-[3-(difluoromethyl)-5-methyl-pyrazol-1-yl]acetyl]-4-piperidyl]-N-tetralin-1-yl-pyridine-2-carboxamide (G.5.4), 4-[1-[2-[3,5-bis(difluoromethyl)pyrazol-1-yl]acetyl]-4-piperidyl]-N-tetralin-1-yl-pyridine-2-carboxamide (G.5.5), 4-[1-[2-[3-(difluoromethyl)-5-(trifluoromethyl)pyrazol-1-yl]acetyl]-4-piperidyl]-N-tetralin-1-yl-pyridine-2-carboxamide (G.5.6), 4-[1-[2-[5-cyclopropyl-3-(difluoromethyl)pyrazol-1-yl]acetyl]-4-piperidyl]-N-tetralin-1-yl-pyridine-2-carboxamide (G.5.7), 4-[1-[2-[5-methyl-3-(trifluoromethyl)pyrazol-1-yl]acetyl]-4-piperidyl]-N-tetralin-1-yl-pyridine-2-carboxamide (G.5.8), 4-[1-[2-[5-(difluoromethyl)-3-(trifluoromethyl)pyrazol-1-yl]acetyl]-4-piperidyl]-N-tetralin-1-yl-pyridine-2-carboxamide (G.5.9), 4-[1-[2-[3,5-bis(trifluoromethyl)pyrazol-1-yl]acetyl]-4-piperidyl]-N-tetralin-1-yl-pyridine-2-carboxamide (G.5.10), (4-[1-[2-[5-cyclopropyl-3-(trifluoromethyl)pyrazol-1-yl]acetyl]-4-piperidyl]-N-tetralin-1-yl-pyridine-2-carboxamide (G.5.11);

H) Inhibitors with Multi Site Action
inorganic active substances: Bordeaux mixture (H.1.1), copper (H.1.2), copper acetate (H.1.3), copper hydroxide (H.1.4), copper oxychloride (H.1.5), basic copper sulfate (H.1.6), sulfur (H.1.7);
thio- and dithiocarbamates: ferbam (H.2.1), mancozeb (H.2.2), maneb (H.2.3), metam (H.2.4), metiram (H.2.5), propineb (H.2.6), thiram (H.2.7), zineb (H.2.8), ziram (H.2.9);
organochlorine compounds: anilazine (H.3.1), chlorothalonil (H.3.2), captafol (H.3.3), captan (H.3.4), folpet (H.3.5), dichlofluanid (H.3.6), dichlorophen (H.3.7), hexachlorobenzene (H.3.8), pentachlorphenole (H.3.9) and its salts, phthalide (H.3.10), tolylfluanid (H.3.11);
guanidines and others: guanidine (H.4.1), dodine (H.4.2), dodine free base (H.4.3), guazatine (H.4.4), guazatine-acetate (H.4.5), iminoctadine (H.4.6), iminoctadine-triacetate (H.4.7), iminoctadine-tris(albesilate) (H.4.8), dithianon (H.4.9), 2,6-dimethyl-1H,5H-[1,4]di-thiino[2,3-c:5,6-c′]dipyrrole-1,3,5,7(2H,6H)-tetraone (H.4.10);

I) Cell Wall Synthesis Inhibitors
inhibitors of glucan synthesis: validamycin (1.1.1), polyoxin B (1.1.2);
melanin synthesis inhibitors: pyroquilon (1.2.1), tricyclazole (1.2.2), carpropamid (1.2.3), dicyclomet (1.2.4), fenoxanil (1.2.5);

J) Plant Defence Inducers
acibenzolar-S-methyl (J.1.1), probenazole (J.1.2), isotianil (J.1.3), tiadinil (J.1.4), prohexadione-calcium (J.1.5); phosphonates: fosetyl (J.1.6), fosetyl-aluminum (J.1.7), phosphorous acid and its salts (J.1.8), calcium phosphonate (J.1.11), potassium phosphonate (J.1.12), potassium or sodium bicarbonate (J.1.9), 4-cyclopropyl-N-(2,4-dimethoxyphenyl)thiadiazole-5-carboxamide (J.1.10);

K) Unknown Mode of Action
bronopol (K.1.1), chinomethionat (K.1.2), cyflufenamid (K.1.3), cymoxanil (K.1.4), dazomet (K.1.5), debacarb (K.1.6), diclocymet (K.1.7), diclomezine (K.1.8), difenzoquat (K.1.9), difenzoquat-methylsulfate (K.1.10), diphenylamin (K.1.11), fenitropan (K.1.12), fenpyrazamine (K.1.13), flumetover (K.1.14), flusulfamide (K.1.15), flutianil (K.1.16), harpin (K.1.17), methasulfocarb (K.1.18), nitrapyrin (K.1.19), nitrothal-isopropyl (K.1.20), tolprocarb (K.1.21), oxincopper (K.1.22), proquinazid (K.1.23), tebufloquin (K.1.24), tecloftalam (K.1.25), triazoxide (K.1.26), N′-(4-(4-chloro-3-trifluoromethyl-phenoxy)-2,5-dimethyl-phenyl)-N-ethyl-N-methyl formamidine (K.1.27), N′-(4-(4-fluoro-3-trifluoromethyl-phenoxy)-2,5-dimethyl-phenyl)-N-ethyl-N-methyl formamidine (K.1.28), N′-[4-[[3-[(4-chlorophenyl)methyl]-1,2,4-thiadiazol-5-yl]oxy]-2,5-dimethyl-phenyl]-N-ethyl-N-methyl-formamidine (K.1.29), N′-(5-bromo-6-indan-2-yloxy-2-methyl-3-pyridyl)-N-ethyl-N-methyl-formamidine (K.1.30), N′-[5-bromo-6-[1-(3,5-difluorophenyl)ethoxy]-2-methyl-3-pyridyl]-N-ethyl-N-methyl-formamidine (K.1.31), N′-[5-bromo-6-(4-isopropylcyclohexoxy)-2-methyl-3-pyridyl]-N-ethyl-N-methyl-formamidine (K.1.32), N′-[5-bromo-2-methyl-6-(1-phenylethoxy)-3-pyridyl]-N-ethyl-N-methyl-formamidine (K.1.33), N′-(2-methyl-5-trifluoromethyl-4-(3-trimethylsilanyl-propoxy)-phenyl)-N-ethyl-N-methyl formamidine (K.1.34), N-(5-difluoromethyl-2-methyl-4-(3-trimethylsilanyl-propoxy)-phenyl)-N-ethyl-N-methyl formamidine (K.1.35), 2-(4-chloro-phenyl)-N-[4-(3,4-dimethoxy-phenyl)-isoxazol-5-yl]-2-prop-2-ynyloxy-acetamide (K.1.36), 3-[5-(4-chloro-phenyl)-2,3-dimethyl-isoxazolidin-3-yl]-pyridine (pyrisoxazole) (K.1.37), 3-[5-(4-methylphenyl)-2,3-dimethyl-isoxazolidin-3 yl]-pyridine (K.1.38), 5-chloro-1-(4,6-dimethoxy-pyrimidin-2-yl)-2-methyl-1H-benzoimidazole (K.1.39), ethyl (Z)-3-amino-2-cyano-3-phenyl-prop-2-enoate (K.1.40), picarbutrazox (K.1.41), pentyl N-[6-[[(Z)-[(1-methyltetrazol-5-yl)-phenyl-methylene]amino]oxymethyl]-2-pyridyl]carbamate (K.1.42), but-3-ynyl N-[6-[[(Z)-[(1-methyltetrazol-5-yl)-phenyl-methylene]amino]oxymethyl]-2-pyridyl]carbamate (K.1.43), ipflufenoquin (K.1.44), quinofumelin (K.1.47), 2-(6-benzyl-2-pyridyl)quinazoline (K.1.50), 2-[6-(3-fluoro-4-methoxy-phenyl)-5-methyl-2-pyridyl]quinazoline (K.1.51), dichlobentiazox (K.1.52), N′-(2,5-dimethyl-4-phenoxy-phenyl)-N-ethyl-N-methyl-formamidine (K.1.53), aminopyrifen (K.1.54), N′-[4-(4,5-dichlorothiazol-2-yl)oxy-2,5-dimethyl-phenyl]-N-ethyl-N-methyl-formamidine (K.1.57), N-methoxy-N-[[4-[5-(trifluoromethyl)-1,2,4-oxadiazol-3-yl]phenyl]methyl]cyclopropanecarboxamide (K.1.58);

M) Growth Regulators

abscisic acid (M.1.1), amidochlor, ancymidol, 6-benzylaminopurine, brassinolide, butralin, chlormequat, chlormequat chloride, choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat, mepiquat chloride, naphthaleneacetic acid, N-6-benzyladenine, paclobutrazol, prohexadione, prohexadione-calcium, prohydrojasmon, thidiazuron, triapenthenol, tributyl phosphorotrithioate, 2,3,5-tri-iodobenzoic acid, trinexapac-ethyl, uniconazole;

N) Herbicides From classes N.1 to N.15

N.1 Lipid biosynthesis inhibitors: alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim, tralkoxydim, 4-(4′-chloro-4-cyclo¬propyl-2′-fluoro[1,1′-biphenyl]-3-yl)-5-hydroxy-2,2,6,6-tetramethyl-2H-pyran-3(6H)-one (1312337-72-6); 4-(2′,4′-dichloro-4-cyclopropyl[1,1′-biphenyl]-3-yl)-5-hydroxy-2,2,6,6-tetramethyl-2H-pyran-3(6H)-one (1312337-45-3); 4-(4′-chloro-4-ethyl-2′-fluoro[1,1′-biphenyl]-3-yl)-5-hydroxy-2,2,6,6-tetramethyl-2H-pyran-3(6H)-one (1033757-93-5); 4-(2′,4′-dichloro-4-ethyl[1,1′-biphenyl]-3-yl)-2,2,6,6-tetramethyl-2H-pyran-3,5(4H,6H)-dione (1312340-84-3); 5-(acetyloxy)-4-(4′-chloro-4-cyclopropyl-2′-fluoro[1,1′-biphenyl]-3-yl)-3,6-dihydro-2,2,6,6-tetramethyl-2H-pyran-3-one (1312337-48-6); 5-(acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(acetyloxy)-4-(4′-chloro-4-ethyl-2′-fluoro[1,1′-biphenyl]-3-yl)-3,6-dihydro-2,2,6,6-tetramethyl-2H-pyran-3-one (1312340-82-1); 5-(acetyloxy)-4-(2′,4′-dichloro-4-ethyl[1,1-biphenyl]-3-yl)-3,6-dihydro-2,2,6,6-tetramethyl-2H-pyran-3-one (1033760-55-2); 4-(4′-chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (1312337-51-1); 4-(2′,4′-dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (1312340-83-2); 4-(2′,4′-dichloro-4-ethyl,[1,1-biphenyl]-3-yl)-5,6-dihydro-2,2,6,6-tetramethyl-5-oxo-2H-pyran-3-yl carbonic acid methyl ester (1033760-58-5); benfuresate, butylate, cycloate, dalapon, dimepiperate, EPTC, esprocarb, ethofumesate, flupropanate, molinate, orbencarb, pebulate, prosulfocarb, TCA, thiobencarb, tiocarbazil, triallate, vernolate;

N.2 ALS inhibitors: amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, iodosulfuron, iodosulfuron-methyl-sodium, iofensulfuron, iofensulfuron-sodium, mesosulfuron, metazosulfuron, metsulfuron, metsulfuron-methyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl, tritosulfuron, imazamethabenz, imazamethabenz-methyl, imazamox, imazapic, imazapyr, imazaquin, imazethapyr; cloransulam, cloransulam-methyl, diclosulam, flumetsulam, florasulam, metosulam, penoxsulam, pyrimisulfan, pyroxsulam; bispyribac, bispyribac-sodium, pyribenzoxim, pyriftalid, pyriminobac, pyriminobac-methyl, pyrithiobac, pyrithiobac-sodium, 4-[[[2-[(4,6-dimethoxy-2-pyrimidinyl)oxy]phenyl]methyl]amino]-benzoic acid-1-methyl¬ethyl ester (420138-41-6), 4-[[[2-[(4,6-dimethoxy-2-pyrimidinyl)oxy]-phenyl]¬methyl]amino]-benzoic acid propyl ester (420138-40-5), N-(4-bromophenyl)-2-[(4,6-dimethoxy-2-pyrimidinyl)oxy]benzenemethanamine (420138-01-8); flucarbazone, flucarbazone-sodium, propoxycarbazone, propoxycarbazone-sodium, thiencarbazone, thiencarbazone-methyl; triafamone;

N.3 Photosynthesis inhibitors: amicarbazone; chlorotriazine; ametryn, atrazine, chloridazone, cyanazine, desmetryn, dimethametryn, hexazinone, metribuzin, prometon, prometryn, propazine, simazine, simetryn, terbumeton, terbuthylazin, terbutryn, trietazin; chlorobromuron, chlorotoluron, chloroxuron, dimefuron, diuron, fluometuron, isoproturon, isouron, linuron, metamitron, methabenzthiazuron, metobenzuron, metoxuron, monolinuron, neburon, siduron, tebuthiuron, thiadiazuron, desmedipham, karbutilat, phenmedipham, phenmedipham-ethyl, bromofenoxim, bromoxynil and its salts and esters, ioxynil and its salts and esters, bromacil, lenacil, terbacil, bentazon, bentazon-sodium, pyridate, pyridafol, pentanochlor, propanil; diquat, diquat-dibromide, paraquat, paraquat-dichloride, paraquat-dimetilsulfate;

N.4 protoporphyrinogen-IX oxidase inhibitors: acifluorfen, acifluorfen-sodium, azafenidin, bencarbazone, benzfendizone, bifenox, butafenacil, carfentrazone, carfentrazone-ethyl, chlor-methoxyfen, cinidon-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, tiafenacil, trifludimoxazin, ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (353292-31-6), N-ethyl-3-(2,6-dichloro-4-trifluoro-methylphenoxy)-5-methyl-1H-pyrazole-1-carboxamide (452098-92-9), N-tetrahydrofurfuryl-3-(2,6-dichloro-4-trifluoromethylphenoxy)-5-methyl-1H-pyrazole-1-carboxamide (915396-43-9), N-ethyl-3-(2-chloro-6-fluoro-4-trifluoromethyl¬phenoxy)-5-methyl-1H-pyrazole-1-carboxamide (452099-05-7), N-tetrahydro¬furfuryl-3-(2-chloro-6-fluoro-4-trifluoro¬methylphenoxy)-5-methyl-1H-pyrazole-1-carboxamide (452100-03-7), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (451484-50-7), 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione (1300118-96-0), 1-methyl-6-trifluoro¬methyl-3-(2,2,7-tri-fluoro-3-oxo-4-prop-2-ynyl-3,4-dihydro-2H-benzo[1,4]oxazin-6-yl)-1H-pyrimidine-2,4-dione (1304113-05-0), methyl (E)-4-[2-chloro-5-[4-chloro-5-(difluoromethoxy)-1H-methyl-pyrazol-3-yl]-4-fluoro-phenoxy]-3-methoxy-but-2-enoate (948893-00-3), 3-[7-chloro-5-fluoro-2-(trifluoromethyl)-1H-benzimidazol-4-yl]-1-methyl-6-(trifluoromethyl)-1H-pyrimidine-2,4-dione (212754-02-4);

N.5 Bleacher herbicides: beflubutamid, diflufenican, fluridone, flurochloridone, flurtamone, norflurazon, picolinafen, 4-(3-trifluoromethylphenoxy)-2-(4-trifluoromethylphenyl)pyrimidine (180608-33-7); benzobicyclon, benzofenap, bicyclopyrone, clomazone, fenquintrione, isoxaflutole, mesotrione, pyrasulfotole, pyrazolynate, pyrazoxyfen, sulcotrione, tefuryltrione, tembotrione, tolpyralate, topramezone; aclonifen, amitrole, flumeturon;

N.6 EPSP synthase inhibitors: glyphosate, glyphosate-isopropylammonium, glyposate-potassium, glyphosate-trimesium (sulfosate);

N.7 Glutamine synthase inhibitors: bilanaphos (bialaphos), bilanaphos-sodium, glufosinate, glufosinate-P, glufosinate-ammonium;

N.8 DHP synthase inhibitors: asulam;

N.9 Mitosis inhibitors: benfluralin, butralin, dinitramine, ethalfluralin, fluchloralin, oryzalin, pen-dimethalin, prodiamine, trifluralin; amiprophos, amiprophos-methyl, butamiphos; chlorthal, chlorthal-dimethyl, dithiopyr, thiazopyr, propyzamide, tebutam; carbetamide, chlorpropham, flamprop, flamprop-isopropyl, flamprop-methyl, flamprop-M-isopropyl, flamprop-M-methyl, propham;

N.10 VLCFA inhibitors: acetochlor, alachlor, butachlor, dimethachlor, dimethenamid, dimethenamid-P, metazachlor, metolachlor, metolachlor-S, pethoxamid, pretilachlor, propachlor, prop-isochlor, thenylchlor, flufenacet, mefenacet, diphenamid, naproanilide, napropamide, napropamide-M, fentrazamide, anilofos, cafenstrole, fenoxasulfone, ipfencarbazone, piperophos, pyroxasulfone, isoxazoline compounds of the formulae II.1, II.2, II.3, II.4, II.5, II.6, II.7, II.8 and II.9

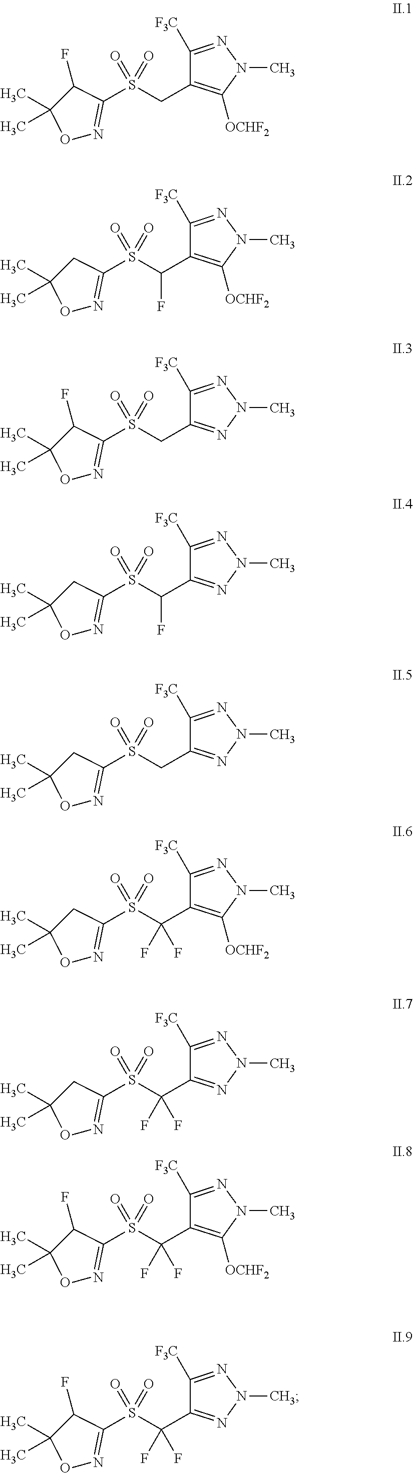

N.11 Cellulose biosynthesis inhibitors: chlorthiamid, dichlobenil, flupoxam, indaziflam, isoxaben, triaziflam, 1-cyclohexyl-5-pentafluorphenyloxy-14-[1,2,4,6]thiatriazin-3-ylamine (175899-01-1);

N.12 Decoupler herbicides: dinoseb, dinoterb, DNOC and its salts;

N.13 Auxinic herbicides: 2,4-D and its salts and esters, clacyfos, 2,4-DB and its salts and esters, aminocyclopyrachlor and its salts and esters, aminopyralid and its salts such as aminopyralid-dimethylammonium, aminopyralid-tris(2-hydroxypropyl)ammonium and its esters, benazolin, benazolin-ethyl, chloramben and its salts and esters, clomeprop, clopyralid and its salts and esters, dicamba and its salts and esters, dichlorprop and its salts and esters, dichlorprop-P and its salts and esters, fluroxypyr, fluroxypyr-butometyl, fluroxypyr-meptyl, halauxifen and its salts and esters (943832-60-8); MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters, triclopyr and its salts and esters, 4-amino-3-chloro-6-(4-chloro-2-fluoro-3-meth-oxyphenyl)-5-fluoropyridine-2-carboxylic acid, benzyl 4-amino-3-chloro-6-(4-chloro-2-fluoro-3-methoxyphenyl)-5-fluoropyridine-2-carboxylate (1390661-72-9);

N.14 Auxin transport inhibitors: diflufenzopyr, diflufenzopyr-sodium, naptalam, naptalam-sodium;

N.15 Other herbicides: bromobutide, chlorflurenol, chlorflurenol-methyl, cinmethylin, cumyluron, cyclopyrimorate (499223-49-3) and its salts and esters, dalapon, dazomet, difenzoquat, di-fenzoquat-metilsulfate, dimethipin, DSMA, dymron, endothal and its salts, etobenzanid, flurenol, flurenol-butyl, flurprimidol, fosamine, fosamine-ammonium, indanofan, maleic hydrazide, mefluidide, metam, methiozolin (403640-27-7), methyl azide, methyl bromide, methyl-dymron, methyl iodide, MSMA, oleic acid, oxaziclomefone, pelargonic acid, pyributicarb, quinoclamine, tridiphane;

O) Insecticides from Classes O.1 to O.29

O.1 Acetylcholine esterase (AChE) inhibitors: aldicarb (O.1.1), alanycarb (O.1.2), bendiocarb (O.1.3), benfuracarb (O.1.4), butocarboxim (O.1.5), butoxycarboxim (O.1.6), carbaryl (O.1.7), carbofuran (O.1.8), carbosulfan (O.1.9), ethiofencarb (O.1.10), fenobucarb (O.1.11), formetanate (O.1.12), furathiocarb (O.1.13), isoprocarb (O.1.14), methiocarb (O.1.15), methomyl (O.1.16), metolcarb (O.1.17), oxamyl (O.1.18), pirimicarb (O.1.19), propoxur (O.1.20), thiodicarb (O.1.21), thiofanox (O.1.22), trimethacarb (O.1.23), XMC (O.1.24), xylylcarb (O.1.25), triazamate (O.1.26), acephate (O.1.27), azamethiphos (O.1.28), azinphos-ethyl (O.1.29), azinphosmethyl (O.1.30), cadusafos (O.1.31), chlorethoxyfos (O.1.32), chlorfenvinphos (O.1.33), chlormephos (O.1.34), chlorpyrifos (O.1.35), chlorpyrifos-methyl (O.1.36), coumaphos (O.1.37), cyanophos (O.1.38), demeton-S-methyl (O.1.39), diazinon (O.1.40), dichlorvos/DDVP (O.1.41), dicrotophos (O.1.42), dimethoate (O.1.43), dimethylvinphos (O.1.44), disulfoton (O.1.45), EPN (O.1.46), ethion (O.1.47), ethoprophos (O.1.48), famphur (O.1.49), fenamiphos (O.1.50), fenitrothion (O.1.51), fenthion (O.1.52), fosthiazate (O.1.53), heptenophos (O.1.54), imicyafos (O.1.55), isofenphos (O.1.56), isopropyl O-(methoxyaminothio-phosphoryl) salicylate (O.1.57), isoxathion (O.1.58), malathion (O.1.59), mecarbam (O.1.60), methamidophos (O.1.61), methidathion (O.1.62), mevinphos (O.1.63), monocrotophos (O.1.64), naled (O.1.65), omethoate (O.1.66), oxydemeton-methyl (O.1.67), parathion (O.1.68), parathion-methyl (O.1.69), phenthoate (O.1.70), phorate (O.1.71), phosalone (O.1.72), phosmet (O.1.73), phosphamidon (O.1.74), phoxim (O.1.75), pirimiphos-methyl (O.1.76), profenofos (O.1.77), propetamphos (O.1.78), prothiofos (O.1.79), pyraclofos (O.1.80), pyridaphenthion (O.1.81), quinalphos (O.1.82), sulfotep (O.1.83), tebupirimfos (O.1.84), temephos (O.1.85), terbufos (O.1.86), tetrachlorvinphos (O.1.87), thiometon (O.1.88), triazophos (O.1.89), trichlorfon (O.1.90), vamidothion (O.1.91);

O.2 GABA-gated chloride channel antagonists: endosulfan (O.2.1), chlordane (O.2.2), ethiprole (O.2.3), fipronil (O.2.4), flufiprole (O.2.5), pyrafluprole (O.2.6), pyriprole (O.2.7);

O.3 Sodium channel modulators: acrinathrin (O.3.1), allethrin (O.3.2), d-cis-trans allethrin (O.3.3), d-trans allethrin (O.3.4), bifenthrin (O.3.5), kappa-bifenthrin (O.3.6), bioallethrin (O.3.7), bioallethrin S-cylclopentenyl (O.3.8), bioresmethrin (O.3.9), cycloprothrin (O.3.10), cyfluthrin (O.3.11), beta-cyfluthrin (O.3.12), cyhalothrin (O.3.13), lambda-cyhalothrin (O.3.14), gamma-cyhalothrin (O.3.15), cypermethrin (O.3.16), alpha-cypermethrin (O.3.17), beta-cypermethrin (O.3.18), theta-cypermethrin (O.3.19), zeta-cypermethrin (O.3.20), cyphenothrin (O.3.21), deltamethrin (O.3.22), empenthrin (O.3.23), esfenvalerate (O.3.24), etofenprox (O.3.25), fenpropathrin (O.3.26), fenvalerate (O.3.27), flucythrinate (O.3.28), flumethrin (O.3.29), tau-fluvalinate (O.3.30), halfenprox (O.3.31), heptafluthrin (O.3.32), imiprothrin (O.3.33), meperfluthrin (O.3.34), metofluthrin (O.3.35), momfluorothrin (O.3.36), epsilon-momfluorothrin (O.3.37), permethrin (O.3.38), phenothrin (O.3.39), prallethrin (O.3.40), profluthrin (O.3.41), pyrethrin (pyrethrum) (O.3.42), resmethrin (O.3.43), silafluofen (O.3.44), tefluthrin (O.3.45), kappa-tefluthrin (O.3.46), tetramethylfluthrin (O.3.47), tetramethrin (O.3.48), tralomethrin (O.3.49), transfluthrin (O.3.50), DDT (O.3.51), methoxychlor (O.3.52);

O.4 Nicotinic acetylcholine receptor agonists (nAChR): acetamiprid (O.4.1), clothianidin (O.4.2), cycloxaprid (O.4.3), dinotefuran (O.4.4), imidacloprid (O.4.5), nitenpyram (O.4.6), thiacloprid (O.4.7), thiamethoxam (O.4.8), 4,5-dihydro-N-nitro-1-(2-oxiranylmethyl)-1H-imidazol-2-amine (O.4.9), (2E)-1-[(6-chloropyridin-3-yl)methyl]-N′-nitro-2-pentylidenehydrazinecarboximidamide (O.4.10), 1-[(6-chloropyridin-3-yl)methyl]-7-methyl-8-nitro-5-propoxy-1,2,3,5,6,7-hexahydroimidazo[1,2-a]pyridine (O.4.11), nicotine (O.4.12), sulfoxaflor (O.4.13), flupyradifurone (O.4.14), triflumezopyrim (O.4.15);

O.5 Nicotinic acetylcholine receptor allosteric activators: spinosad (O.5.1), spinetoram (O.5.2);

O.6 Chloride channel activators: abamectin (O.6.1), emamectin benzoate (O.6.2), ivermectin (O.6.3), lepimectin (O.6.4), milbemectin (O.6.5);

O.7 Juvenile hormone mimics: hydroprene (O.7.1), kinoprene (O.7.2), methoprene (O.7.3), fenoxycarb (O.7.4), pyriproxyfen (O.7.5);

O.8 miscellaneous non-specific (multi-site) inhibitors: methyl bromide (O.8.1) and other alkyl halides, chloropicrin (O.8.2), sulfuryl fluoride (O.8.3), borax (O.8.4), tartar emetic (O.8.5);

O.9 Chordotonal organ TRPV channel modulators: pymetrozine (O.9.1), pyrifluquinazon (O.9.2), flonicamid (O.9.3);

O.10 Mite growth inhibitors: clofentezine (O.10.1), hexythiazox (O.10.2), diflovidazin (O.10.3), etoxazole (O.10.4);

O.11 Microbial disruptors of insect midgut membranes: Bacillus thuringiensis, Bacillus sphaericus and the insecticidal proteins they produce: Bacillus thuringiensis subsp. Israelensis (O.11.1), Bacillus sphaericus (O.11.2), Bacillus thuringiensis subsp. aizawai (O.11.3), Bacillus thuringiensis subsp. kurstaki (O.11.4), Bacillus thuringiensis subsp. tenebrionis (O.11.5), the Bt crop proteins: Cry1Ab (O.11.6), Cry1Ac (O.11.7), Cry1Fa (O.11.8), Cry2Ab (O.11.9), mCry3A (O.11.10), Cry3Ab (O.11.11), Cry3Bb (O.11.12), Cry34/35Ab1 (O.11.13);

O.12 Inhibitors of mitochondrial ATP synthase: diafenthiuron (O.12.1), azocyclotin (O.12.2), cyhexatin (O.12.3), fenbutatin oxide (O.12.4), propargite (O.12.5), tetradifon (O.12.6);

O.13 Uncouplers of oxidative phosphorylation via disruption of the proton gradient: chlorfenapyr (O.13.1), DNOC (O.13.2), sulfluramid (O.13.3);

O.14 Nicotinic acetylcholine receptor (nAChR) channel blockers: bensultap (O.14.1), cartap hydrochloride (O.14.2), thiocyclam (O.14.3), thiosultap sodium (O.14.4);

O.15 Inhibitors of the chitin biosynthesis type 0: bistrifluron (O.15.1), chlorfluazuron (O.15.2), diflubenzuron (O.15.3), flucycloxuron (O.15.4), flufenoxuron (O.15.5), hexaflumuron (O.15.6), lufenuron (O.15.7), novaluron (O.15.8), noviflumuron (O.15.9), teflubenzuron (O.15.10), triflumuron (O.15.11);

O.16 Inhibitors of the chitin biosynthesis type 1: buprofezin (O.16.1);

O.17 Moulting disruptors: cyromazine (O.17.1);

O.18 Ecdyson receptor agonists: methoxyfenozide (O.18.1), tebufenozide (O.18.2), halofenozide (O.18.3), fufenozide (O.18.4), chromafenozide (O.18.5);

O.19 Octopamin receptor agonists: amitraz (O.19.1);

O.20 Mitochondrial complex Ill electron transport inhibitors: hydramethylnon (O.20.1), acequinocyl (O.20.2), fluacrypyrim (O.20.3), bifenazate (O.20.4);

O.21 Mitochondrial complex I electron transport inhibitors: fenazaquin (O.21.1), fenpyroximate (O.21.2), pyrimidifen (O.21.3), pyridaben (O.21.4), tebufenpyrad (O.21.5), tolfenpyrad (O.21.6), rotenone (O.21.7);

O.22 Voltage-dependent sodium channel blockers: indoxacarb (O.22.1), metaflumizonev (O.22.2), 2-[2-(4-cyanophenyl)-1-[3-(trifluoromethyl)phenyl]ethylidene]-N-[4-(difluoromethoxy)phenyl]-hydrazinecarboxamide (O.22.3), N-(3-chloro-2-methylphenyl)-2-[(4-chlorophenyl)-[4-[methyl(methylsulfonyl)amino]phenyl]methylene]-hydrazinecarboxamide (O.22.4);

O.23 Inhibitors of the of acetyl CoA carboxylase: spirodiclofen (O.23.1), spiromesifen (O.23.2), spirotetramat (O.23.3), spiropidion (O.23.4);

O.24 Mitochondrial complex IV electron transport inhibitors: aluminium phosphide (O.24.1), calcium phosphide (O.24.2), phosphine (O.24.3), zinc phosphide (O.24.4), cyanide (O.24.5);

O.25 Mitochondrial complex II electron transport inhibitors: cyenopyrafen (O.25.1), cyflumetofen (O.25.2);

O.26 Ryanodine receptor-modulators: flubendiamide (O.26.1), chlorantraniliprole (O.26.2), cyantraniliprole (O.26.3), cyclaniliprole (O.26.4), tetraniliprole (O.26.5), (R)-3-chloro-N¹-{2-methyl-4-[1,2,2,2-tetrafluoro-1-(trifluoromethyl)ethyl]phenyl}-N²-(1-methyl-2-methylsulfonylethyl)phthalamide (O.26.6), (S)-3-chloro-N¹-{2-methyl-4-[1,2,2,2-tetrafluoro-1-(trifluoromethyl)ethyl]phenyl}-N²-(1-methyl-2-methylsulfonylethyl)phthalamide (O.26.7), methyl-2-[3,5-dibromo-2-({[3-bromo-1-(3-chloropyridin-2-yl)-1H-pyrazol-5-yl]carbonyl}amino)benzoyl]-1,2-dimethylhydrazinecarboxylate (O.26.8), N-[4,6-dichloro-2-[(diethyl-lambda-4-sulfanylidene)-carbamoyl]-phenyl]-2-(3-chloro-2-pyridyl)-5-(trifluoromethyl)pyrazole-3-carboxamide (O.26.9), N-[4-chloro-2-[(diethyl-lambda-4-sulfanylidene)carbamoyl]-6-methyl-phenyl]-2-(3-chloro-2-pyridyl)-5-(trifluoromethyl)pyrazole-3-carboxamide (O.26.10), N-[4-chloro-2-[(di-2-propyl-lambda-4-sulfanylidene)carbamoyl]-6-methyl-phenyl]-2-(3-chloro-2-pyridyl)-5-(trifluoromethyl)pyrazole-3-carboxamide (O.26.11), N-[4,6-dichloro-2-[(di-2-propyl-lambda-4-sulfanylidene)carbamoyl]-phenyl]-2-(3-chloro-2-pyridyl)-5-(trifluoromethyl)pyrazole-3-carboxamide (O.26.12), N-[4,6-dibromo-2-[(diethyl-lambda-4-sulfanylidene)carbamoyl]-phenyl]-2-(3-chloro-2-pyridyl)-5-(trifluoro-methyl)pyrazole-3-carboxamide (O.26.13), N-[2-(5-amino-1,3,4-thiadiazol-2-yl)-4-chloro-6-methylphenyl]-3-bromo-1-(3-chloro-2-pyridinyl)-1H-pyrazole-5-carboxamide (O.26.14), 3-chloro-1-(3-chloro-2-pyridinyl)-N-[2,4-dichloro-6-[[(1-cyano-1-methylethyl)amino]carbonyl]phenyl]-1H-pyrazole-5-carboxamide (O.26.15), 3-bromo-N-[2,4-dichloro-6-(methylcarbamoyl)phenyl]-1-(3,5-dichloro-2-pyridyl)-1H-pyrazole-5-carboxamide (O.26.16), N-[4-chloro-2-[[(1,1-dimethylethyl)amino]carbonyl]-6-methylphenyl]-1-(3-chloro-2-pyridinyl)-3-(fluoromethoxy)-1H-pyrazole-5-carboxamide (O.26.17), cyhalodiamide (O.26.18);

O.27: Chordotonal organ Modulators—undefined target site: flonicamid (O.27.1);

O.28. insecticidal active compounds of unknown or uncertain mode of action: afidopyropen (O.28.1), afoxolaner (O.28.2), azadirachtin (O.28.3), amidoflumet (O.28.4), benzoximate (O.28.5), broflanilide (O.28.6), bromopropylate (O.28.7), chinomethionat (O.28.8), cryolite (O.28.9), dicloromezotiaz (O.28.10), dicofol (O.28.11), flufenerim (O.28.12), flometoquin (O.28.13), fluensulfone (O.28.14), fluhexafon (O.28.15), fluopyram (O.28.16), fluralaner (O.28.17), metoxadiazone (O.28.18), piperonyl butoxide (O.28.19), pyflubumide (O.28.20), pyridalyl (O.28.21), tioxazafen (O.28.22), 11-(4-chloro-2,6-dimethylphenyl)-12-hydroxy-1,4-dioxa-9-azadispiro[4.2.4.2]-tetradec-11-en-10-one, 3-(4′-fluoro-2,4-dimethylbiphenyl-3-yl)-4-hydroxy-8-oxa-1-azaspiro[4.5]dec-3-en-2-one, 1-[2-fluoro-4-methyl-5-[(2,2,2-trifluoroethyl)sulfinyl]phenyl]-3-(trifluoromethyl)-1H-1,2,4-triazole-5-amine (O.28.23), Bacillus firmus 1-1582 (O.28.24), flupyrimin (O.28.25), fluazaindolizine (O.28.26), 4-[5-(3,5-di-chlorophenyl)-5-(trifluoromethyl)-4H-isoxazol-3-yl]-2-methyl-N-(1-oxothietan-3-yl)benzamide (O.28.27), fluxametamide (O.28.28), 5-[3-[2,6-dichloro-4-(3,3-dichloroallyloxy)phenoxy]propoxy]-1H-pyrazole (O.28.1), 4-cyano-N-[2-cyano-5-[[2,6-dibromo-4-[1,2,2,3,3,3-hexafluoro-1-(trifluoromethyl)propyl]phenyl]carbamoyl]phenyl]-2-methyl-benzamide (O.28.29), 4-cyano-3-[(4-cyano-2-methyl-benzoyl)amino]-N-[2,6-dichloro-4-[1,2,2,3,3,3-hexafluoro-1-(trifluoromethyl)propyl]phenyl]-2-fluoro-benzamide (O.28.30), N-[5-[[2-chloro-6-cyano-4-[1,2,2,3,3,3-hexafluoro-1-(trifluoromethyl)propyl]phenyl]carbamoyl]-2-cyano-phenyl]-4-cyano-2-methyl-benzamide (O.28.31), N-[5-[[2-bromo-6-chloro-4-[2,2,2-trifluoro-1-hydroxy-1-(trifluoromethyl)ethyl]phenyl]carbamoyl]-2-cyano-phenyl]-4-cyano-2-methyl-benzamide (O.28.32), N-[5-[[2-bromo-6-chloro-4-[1,2,2,3,3,3-hexafluoro-1-(trifluoromethyl)-propyl]phenyl]carbamoyl]-2-cyano-phenyl]-4-cyano-2-methyl-benzamide (O.28.33), 4-cyano-N-[2-cyano-5-[[2,6-dichloro-4-[1,2,2,3,3,3-hexafluoro-1-(trifluoromethyl)propyl]phenyl]carbamoyl]phenyl]-2-methyl-benzamide (O.28.34), 4-cyano-N-[2-cyano-5-[[2,6-dichloro-4-[1,2,2,2-tetrafluoro-1-(trifluoromethyl)ethyl]phenyl]carbamoyl]phenyl]-2-methyl-benzamide (O.28.35), N-[5-[[2-bromo-6-chloro-4-[1,2,2,2-tetrafluoro-1-(trifluoromethyl)ethyl]phenyl]carbamoyl]-2-cyano-phenyl]-4-cyano-2-methyl-benzamide (O.28.36); 2-(1,3-dioxan-2-yl)-6-[2-(3-pyridinyl)-5-thiazolyl]-pyridine (O.28.37), 2-[6-[2-(5-fluoro-3-pyridinyl)-5-thiazolyl]-2-pyridinyl]-pyrimidine (O.28.38), 2-[6-[2-(3-pyridinyl)-5-thiazolyl]-2-pyridinyl]-pyrimidine (O.28.39), N-methylsulfonyl-6-[2-(3-pyridyl)thiazol-5-yl]pyridine-2-carboxamide (O.28.40), N-methylsulfonyl-6-[2-(3-pyridyl)thiazol-5-yl]pyridine-2-carboxamide (O.28.41), 1-[(6-chloro-3-pyridinyl)methyl]-1,2,3,5,6,7-hexahydro-5-methoxy-7-methyl-8-nitro-imidazo[1,2-a]pyridine (O.28.42), 1-[(6-chloropyridin-3-yl)methyl]-7-methyl-8-nitro-1,2,3,5,6,7-hexahydroimidazo[1,2-a]pyridin-5-ol (O.28.43), 1-isopropyl-N,5-dimethyl-N-pyridazin-4-yl-pyrazole-4-carboxamide (O.28.44), 1-(1,2-dimethylpropyl)-N-ethyl-5-methyl-N-pyridazin-4-yl-pyrazole-4-carboxamide (O.28.45), N,5-dimethyl-N-pyridazin-4-yl-1-(2,2,2-trifluoro-1-methyl-ethyl)pyrazole-4-carboxamide (O.28.46), 1-[1-(1-cyanocyclopropyl)ethyl]-N-ethyl-5-methyl-N-pyridazin-4-yl-pyrazole-4-carboxamide (O.28.47), N-ethyl-1-(2-fluoro-1-methyl-propyl)-5-meth-yl-N-pyridazin-4-yl-pyrazole-4-carboxamide (O.28.48), 1-(1,2-dimethylpropyl)-N,5-dimethyl-N-pyridazin-4-yl-pyrazole-4-carboxamide (O.28.49), 1-[1-(1-cyanocyclopropyl)ethyl]-N,5-dimethyl-N-pyridazin-4-yl-pyrazole-4-carboxamide (O.28.50), N-methyl-1-(2-fluoro-1-methyl-propyl]-5-methyl-N-pyridazin-4-yl-pyrazole-4-carboxamide (O.28.51), 1-(4,4-difluorocyclohexyl)-N-ethyl-5-methyl-N-pyridazin-4-yl-pyrazole-4-carboxamide (O.28.52), 1-(4,4-difluorocyclohexyl)-N,5-dimethyl-N-pyridazin-4-yl-pyrazole-4-carboxamide (O.28.53), N-(1-methylethyl)-2-(3-pyridinyl)-2H-indazole-4-carboxamide (O.28.54), N-cyclopropyl-2-(3-pyridinyl)-2H-indazole-4-carboxamide (O.28.55), N-cyclohexyl-2-(3-pyridinyl)-2H-indazole-4-carboxamide (O.28.56), 2-(3-pyridinyl)-N-(2,2,2-trifluoroethyl)-2H-indazole-4-carboxamide (O.28.57), 2-(3-pyridinyl)-N-[(tetrahydro-2-furanyl)methyl]-2H-indazole-5-carboxamide (O.28.58), methyl 2-[[2-(3-pyridinyl)-2H-indazol-5-yl]carbonyl]hydrazinecarboxylate (O.28.59), N-[(2,2-difluorocyclopropyl)methyl]-2-(3-pyridinyl)-2H-indazole-5-carboxamide (O.28.60), N-(2,2-difluoropropyl)-2-(3-pyridinyl)-2H-indazole-5-carboxamide (O.28.61), 2-(3-pyridinyl)-N-(2-pyrimidinylmethyl)-2H-indazole-5-carboxamide (O.28.62), N-[(5-methyl-2-pyrazinyl)methyl]-2-(3-pyridinyl)-2H-indazole-5-carboxamide (O.28.63), tyclopyrazoflor (O.28.64), sarolaner (O.28.65), lotilaner (O.28.66), N-[4-chloro-3-[[(phenylmethyl)amino]carbonyl]phenyl]-1-methyl-3-(1,1,2,2,2-pentafluoroethyl)-4-(trifluoromethyl)-1H-pyrazole-5-carboxamide (O.28.67), M.UN.22a 2-(3-ethylsulfonyl-2-pyridyl)-3-methyl-6-(trifluoromethyl)imidazo[4,5-b]pyridine (O.28.68), 2-[3-ethylsulfonyl-5-(trifluoromethyl)-2-pyridyl]-3-methyl-6-(trifluoromethyl)imidazo[4,5-b]pyridine (O.28.69), 4-[5-(3,5-dichlorophenyl)-5-(trifluoromethyl)-4H-isoxazol-3-yl]-N-[(4R)-2-ethyl-3-oxo-isoxazolidin-4-yl]-2-methyl-benzamide (O.28.70), 4-[5-(3,5-dichloro-4-fluoro-phenyl)-5-(trifluoromethyl)-4H-isoxazol-3-yl]-N-[(4R)-2-ethyl-3-oxo-isoxazolidin-4-yl]-2-methyl-benzamide (O.28.71), N-[4-chloro-3-(cyclopropylcarbamoyl)phenyl]-2-methyl-5-(1,1,2,2,2-pentafluoroethyl)-4-(trifluoromethyl)pyrazole-3-carboxamide (O.28.72), N-[4-chloro-3-[(1-cyanocyclopropyl)-carbamoyl]phenyl]-2-methyl-5-(1,1,2,2,2-pentafluoroethyl)-4-(trifluoromethyl)pyrazole-3-carboxamide (O.28.73), acynonapyr (O.28.74), benzpyrimoxan (O.28.75), chloro-N-(1-cyanocyclopropyl)-5-[1-[2-methyl-5-(1,1,2,2,2-pentafluoroethyl)-4-(trifluoromethyl)pyrazol-3-yl]pyrazol-4-yl]benzamide (O.28.76), oxazosulfyl (O.28.77), [(2S,3R,4R,5S,6S)-3,5-dimethoxy-6-methyl-4-propoxy-tetrahydropyran-2-yl]-N-[4-[1-[4-(trifluoromethoxy)phenyl]-1,2,4-triazol-3-yl]phenyl]carbamate (O.28.78), [(2S,3R,4R,5S,6S)-3,4,5-trimethoxy-6-methyl-tetrahydropyran-2-yl] N-[4-[1-[4-(trifluoromethoxy)phenyl]-1,2,4-triazol-3-yl]phenyl]carbamate (O.28.79), [(2S,3R,4R,5S,6S)-3,5-dimethoxy-6-methyl-4-propoxy-tetrahydropyran-2-yl]-N-[4-[1-[4-(1,1,2,2,2-pentafluoroethoxy)phenyl]-1,2,4-triazol-3-yl]phenyl]carbamate (O.28.80), [(2S,3R,4R,5S,6S)-3,4,5-trimethoxy-6-methyl-tetrahydropyran-2-yl]-N-[4-[1-[4-(1,1,2,2,2-penta-fluoroethoxy)phenyl]-1,2,4-triazol-3-yl]phenyl]carbamate (O.28.81), (2Z)-3-(2-isopropylphenyl)-2-[(E)-[4-[1-[4-(1,1,2,2,2-pentafluoroethoxy)phenyl]-1,2,4-triazol-3-yl]phenyl]methylenehydrazono]thiazolidin-4-one (O.28.82).

The active substances referred to as component 2, their preparation and their activity e.g. against harmful fungi is known (cf.: http://www.alanwood.net/pesticides/); these substances are commercially available. The compounds described by IUPAC nomenclature, their preparation and their pesticidal activity are also known (cf. Can. J. Plant Sci. 48(6), 587-94, 1968; EP-A 141 317; EP-A 152 031; EP-A 226 917; EP-A 243 970; EP-A 256 503; EP-A 428 941; EP-A 532 022; EP-A 1 028 125; EP-A 1 035 122; EP-A 1 201 648; EP-A 1 122 244, JP 2002316902; DE 19650197; DE 10021412; DE 102005009458; U.S. Pat. Nos. 3,296,272; 3,325,503; WO 98/46608; WO 99/14187; WO 99/24413; WO 99/27783; WO 00/29404; WO 00/46148; WO 00/65913; WO 01/54501; WO 01/56358; WO 02/22583; WO 02/40431; WO 03/10149; WO 03/11853; WO 03/14103; WO 03/16286; WO 03/53145; WO 03/61388; WO 03/66609; WO 03/74491; WO 04/49804; WO 04/83193; WO 05/120234; WO 05/123689; WO 05/123690; WO 05/63721; WO 05/87772; WO 05/87773; WO 06/15866; WO 06/87325; WO 06/87343; WO 07/82098; WO 07/90624, WO 10/139271, WO 11/028657, WO 12/168188, WO 07/006670, WO 11/77514; WO 13/047749, WO 10/069882, WO 13/047441, WO 03/16303, WO 09/90181, WO 13/007767, WO 13/010862, WO 13/127704, WO 13/024009, WO 13/24010, WO 13/047441, WO 13/162072, WO 13/092224, WO 11/135833, CN 1907024, CN 1456054, CN 103387541, CN 1309897, WO 12/84812, CN 1907024, WO 09094442, WO 14/60177, WO 13/116251, WO 08/013622, WO 15/65922, WO 94/01546, EP 2865265, WO 07/129454, WO 12/165511, WO 11/081174, WO 13/47441, WO 16/156241, WO 16/162265). Some compounds are identified by their CAS Registry Number which is separated by hyphens into three parts, the first consisting from two up to seven digits, the second consisting of two digits, and the third consisting of a single digit.

In the binary mixtures the weight ratio of the component 1) and the component 2) generally depends from the properties of the components used, usually it is in the range of from 1:10,000 to 10,000:1, often from 1:100 to 100:1, regularly from 1:50 to 50:1, preferably from 1:20 to 20:1, more preferably from 1:10 to 10:1, even more preferably from 1:4 to 4:1 and in particular from 1:2 to 2:1. According to further embodiments, the weight ratio of the component 1) and the component 2) usually is in the range of from 1000:1 to 1:1, often from 100:1 to 1:1, regularly from 50:1 to 1:1, preferably from 20:1 to 1:1, more preferably from 10:1 to 1:1, even more preferably from 4:1 to 1:1 and in particular from 2:1 to 1:1. According to further embodiments, the weight ratio of the component 1) and the component 2) usually is in the range of from 20,000:1 to 1:10, often from 10,000:1 to 1:1, regularly from 5,000:1 to 5:1, preferably from 5,000:1 to 10:1, more preferably from 2,000:1 to 30:1, even more preferably from 2,000:1 to 100:1 and in particular from 1,000:1 to 100:1. According to further embodiments, the weight ratio of the component 1) and the component 2) usually is in the range of from 1:1 to 1:1000, often from 1:1 to 1:100, regularly from 1:1 to 1:50, preferably from 1:1 to 1:20, more preferably from 1:1 to 1:10, even more preferably from 1:1 to 1:4 and in particular from 1:1 to 1:2. According to further embodiments, the weight ratio of the component 1) and the component 2) usually is in the range of from 10:1 to 1:20,000, often from 1:1 to 1:10,000, regularly from 1:5 to 1:5,000, preferably from 1:10 to 1:5,000, more preferably from 1:30 to 1:2,000, even more preferably from 1:100 to 1:2,000 to and in particular from 1:100 to 1:1,000.

In the ternary mixtures, i.e. compositions comprising the component 1) and component 2) and a compound Ill (component 3), the weight ratio of component 1) and component 2) depends from the properties of the active substances used, usually it is in the range of from 1:100 to 100:1, regularly from 1:50 to 50:1, preferably from 1:20 to 20:1, more preferably from 1:10 to 10:1 and in particular from 1:4 to 4:1, and the weight ratio of component 1) and component 3) usually it is in the range of from 1:100 to 100:1, regularly from 1:50 to 50:1, preferably from 1:20 to 20:1, more preferably from 1:10 to 10:1 and in particular from 1:4 to 4:1. Any further active components are, if desired, added in a ratio of from 20:1 to 1:20 to the component 1). These ratios are also suitable for mixtures applied by seed treatment.

Accordingly, the present invention furthermore relates to mixtures comprising one compound of the formula I (component 1, a group represented by the expression “(1)”) and one pesticide II (component 2), wherein pesticide II is an active ingredients selected from the groups A) to O) defined above.

Further embodiments B-1 to B-689 listed in Table B below relate to mixtures comprising as active components one of the in the present specification individualized compounds of the formula I, which is selected from the group of compounds as defined in tables 1 to 48 (component 1, a group represented by the expression “(I)”) and one pesticide II selected from the groups A) to O) as defined herein (component 2, for example, (A.1.1) or azoxystrobin, in embodiment B-1).

Further embodiments B-1 to B-689 listed in Table B below relate to the mixtures comprising as active components one of the in the present specification individualized compounds of the formula I, which is selected from the group of compounds I-1 to I-8 as defined in Table I below (component 1, a group represented by the expression “(I)”) and one pesticide II selected from the groups A) to O) as defined herein (component 2).

Preferably, the compositions described in Table B comprise the active components in synergistically effective amounts.

Table B:

B-1: (I)+(A.1.1), B-2: (I)+(A.1.2), B-3: (I)+(A.1.3), B-4: (I)+(A.1.4), B-5: (I)+(A.1.5), B-6: (I)+(A.1.6), B-7: (I)+(A.1.7), B-8: (I)+(A.1.8), B-9: (I)+(A.1.9), B-10: (I)+(A.1.10), B-11: (I)+(A.1.11), B-12: (I)+(A.1.12), B-13: (I)+(A.1.13), B-14: (I)+(A.1.14), B-15: (I)+(A.1.15), B-16: (I)+(A.1.16), B-17: (I)+(A.1.17), B-18: (I)+(A.1.18), B-19: (I)+(A.1.19), B-20: (I)+(A.1.20), B-21: (I)+(A.1.21), B-22: (I)+(A.1.21a), B-23: (I)+(A.1.22), B-24: (I)+(A.1.25), B-25: (I)+(A.1.34), B-26: (I)+(A.1.35), B-27: (I)+(A.1.36), B-28: (I)+(A.1.37), B-29: (I)+(A.1.38), B-30: (I)+(A.2.1), B-31: (I)+(A.2.2), B-32: (I)+(A.2.3), B-33: (I)+(A.2.4), B-34: (I)+(A.2.5), B-35: (I)+(A.3.1), B-36: (I)+(A.3.2), B-37: (I)+(A.3.3), B-38: (I)+(A.3.4), B-39: (I)+(A.3.5), B-40: (I)+(A.3.6), B-41: (I)+(A.3.7), B-42: (I)+(A.3.8), B-43: (I)+(A.3.9), B-44: (I)+(A.3.10), B-45: (I)+(A.3.11), B-46: (I)+(A.3.12), B-47: (I)+(A.3.13), B-48: (I)+(A.3.14), B-49: (I)+(A.3.15), B-50: (I)+(A.3.16), B-51: (I)+(A.3.17), B-52: (I)+(A.3.18), B-53: (I)+(A.3.19), B-54: (I)+(A.3.20), B-55: (I)+(A.3.21), B-56: (I)+(A.3.22), B-57: (I)+(A.3.23), B-58: (I)+(A.3.24), B-59: (I)+(A.3.25), B-60: (I)+(A.3.26), B-61: (I)+(A.3.27), B-62: (I)+(A.3.28), B-63: (I)+(A.3.30), B-64: (I)+(A.3.31), B-65: (I)+(A.3.32), B-66: (I)+(A.3.33), B-67: (I)+(A.3.34), B-68: (I)+(A.3.35), B-69: (I)+(A.3.36), B-70: (I)+(A.3.37), B-71: (I)+(A.3.38), B-72: (I)+(A.3.39), B-73: (I)+(A.4.1), B-74: (I)+(A.4.2), B-75: (I)+(A.4.3), B-76: (I)+(A.4.4), B-77: (I)+(A.4.5), B-78: (I)+(A.4.6), B-79: (I)+(A.4.7), B-80: (I)+(A.4.8), B-81: (I)+(A.4.9), B-82: (I)+(A.4.10), B-83: (I)+(A.4.11), B-84: (I)+(A.4.12), B-85: (I)+(B.1.1), B-86: (I)+(B.1.2), B-87: (I)+(B.1.3), B-88: (I)+(B.1.4), B-89: (I)+(B.1.5), B-90: (I)+(B.1.6), B-91: (I)+(B.1.7), B-92: (I)+(B.1.8), B-93: (I)+(B.1.9), B-94: (I)+(B.1.10), B-95: (I)+(B.1.11), B-96: (I)+(B.1.12), B-97: (I)+(B.1.13), B-98: (I)+(B.1.14), B-99: (I)+(B.1.15), B-100: (I)+(B.1.16), B-101: (I)+(B.1.17), B-102: (I)+(B.1.18), B-103: (I)+(B.1.19), B-104: (I)+(B.1.20), B-105: (I)+(B.1.21), B-106: (I)+(B.1.22), B-107: (I)+(B.1.23), B-108: (I)+(B.1.24), B-109: (I)+(B.1.25), B-110: (I)+(B.1.26), B-111: (I)+(B.1.27), B-112: (I)+(B.1.28), B-113: (I)+(B.1.29), B-114: (I)+(B.1.30), B-115: (I)+(B.1.31), B-116: (I)+(B.1.32), B-117: (I)+(B.1.37), B-118: (I)+(B.1.38), B-119: (I)+(B.1.39), B-120: (I)+(B.1.40), B-121: (I)+(B.1.41), B-122: (I)+(B.1.42), B-123: (I)+(B.1.43), B-124: (I)+(B.1.44), B-125: (I)+(B.1.45), B-126: (I)+(B.1.46), B-127: (I)+(B.1.47), B-128: (I)+(B.1.48), B-129: (I)+(B.1.49), B-130: (I)+(B.1.50), B-131: (I)+(B.1.51), B-132: (I)+(B.1.52), B-133: (I)+(B.2.1), B-134: (I)+(B.2.2), B-135: (I)+(B.2.3), B-136: (I)+(B.2.4), B-137: (I)+(B.2.5), B-138: (I)+(B.2.6), B-139: (I)+(B.2.7), B-140: (I)+(B.2.8), B-141: (I)+(B.3.1), B-142: (I)+(B.4.1), B-143: (I)+(C.1.1), B-144: (I)+(C.1.2), B-145: (I)+(C.1.3), B-146: (I)+(C.1.4), B-147: (I)+(C.1.5), B-148: (I)+(C.1.6), B-149: (I)+(C.1.7), B-150: (I)+(C.2.1), B-151: (I)+(C.2.2), B-152: (I)+(C.2.3), B-153: (I)+(C.2.4), B-154: (I)+(C.2.5), B-155: (I)+(C.2.6), B-156: (I)+(C.2.7), B-157: (I)+(C.2.8), B-158: (I)+(D.1.1), B-159: (I)+(D.1.2), B-160: (I)+(D.1.3), B-161: (I)+(D.1.4), B-162: (I)+(D.1.5), B-163: (I)+(D.1.6), B-164: (I)+(D.1.7), B-165: (I)+(D.1.8), B-166: (I)+(D.1.9), B-167: (I)+(D.1.10), B-168: (I)+(D.1.11), B-169: (I)+(D.1.12), B-170: (I)+(D.1.13), B-171: (I)+(D.1.14), B-172: (I)+(D.1.15), B-173: (I)+(D.1.16), B-174: (I)+(D.2.1), B-175: (I)+(D.2.2), B-176: (I)+(D.2.3), B-177: (I)+(D.2.4), B-178: (I)+(D.2.5), B-179: (I)+(D.2.6), B-180: (I)+(D.2.7), B-181: (I)+(E.1.1), B-182: (I)+(E.1.2), B-183: (I)+(E.1.3), B-184: (I)+(E.2.1), B-185: (I)+(E.2.2), B-186: (I)+(E.2.3), B-187: (I)+(E.2.4), B-188: (I)+(E.2.5), B-189: (I)+(E.2.6), B-190: (I)+(F.1.1), B-191: (I)+(F.1.2), B-192: (I)+(F.1.3), B-193: (I)+(F.1.4), B-194: (I)+(F.1.5), B-195: (I)+(F.2.1), B-196: (I)+(G.1.1), B-197: (I)+(G.1.2), B-198: (I)+(G.1.3), B-199: (I)+(G.1.4), B-200: (I)+(G.2.1), B-201: (I)+(G.2.2), B-202: (I)+(G.2.3), B-203: (I)+(G.2.4), B-204: (I)+(G.2.5), B-205: (I)+(G.2.6), B-206: (I)+(G.2.7), B-207: (I)+(G.3.1), B-208: (I)+(G.3.2), B-209: (I)+(G.3.3), B-210: (I)+(G.3.4), B-211: (I)+(G.3.5), B-212: (I)+(G.3.6), B-213: (I)+(G.3.7), B-214: (I)+(G.4.1), B-215: (I)+(G.5.1), B-216: (I)+(G.5.2), B-217: (I)+(G.5.3), B-218: (I)+(G.5.4), B-219: (I)+(G.5.5), B-220: (I)+(G.5.6), B-221: (I)+(G.5.7), B-222: (I)+(G.5.8), B-223: (I)+(G.5.9), B-224: (I)+(G.5.10), B-225: (I)+(G.5.11), B-226: (I)+(H.1.1), B-227: (I)+(H.1.2), B-228: (I)+(H.1.3), B-229: (I)+(H.1.4), B-230: (I)+(H.1.5), B-231: (I)+(H.1.6), B-232: (I)+(H.1.7), B-233: (I)+(H.2.1), B-234: (I)+(H.2.2), B-235: (I)+(H.2.3), B-236: (I)+(H.2.4), B-237: (I)+(H.2.5), B-238: (I)+(H.2.6), B-239: (I)+(H.2.7), B-240: (I)+(H.2.8), B-241: (I)+(H.2.9), B-242: (I)+(H.3.1), B-243: (I)+(H.3.2), B-244: (I)+(H.3.3), B-245: (I)+(H.3.4), B-246: (I)+(H.3.5), B-247: (I)+(H.3.6), B-248: (I)+(H.3.7), B-249: (I)+(H.3.8), B-250: (I)+(H.3.9), B-251: (I)+(H.3.10), B-252: (I)+(H.3.11), B-253: (I)+(H.4.1), B-254: (I)+(H.4.2), B-255: (I)+(H.4.3), B-256: (I)+(H.4.4), B-257: (I)+(H.4.5), B-258: (I)+(H.4.6), B-259: (I)+(H.4.7), B-260: (I)+(H.4.8), B-261: (I)+(H.4.9), B-262: (I)+(H.4.10), B-263: (I)+(I.1.1), B-264: (I)+(I.1.2), B-265: (I)+(I.2.1), B-266: (I)+(I.2.2), B-267: (I)+(I.2.3), B-268: (I)+(I.2.4), B-269: (I)+(I.2.5), B-270: (I)+(J.1.1), B-271: (I)+(J.1.2), B-272: (I)+(J.1.3), B-273: (I)+(J.1.4), B-274: (I)+(J.1.5), B-275: (I)+(J.1.6), B-276: (I)+(J.1.7), B-277: (I)+(J.1.8), B-278: (I)+(J.1.9), B-279: (I)+(J.1.10), B-280: (I)+(K.1.1), B-281: (I)+(K.1.2), B-282: (I)+(K.1.3), B-283: (I)+(K.1.4), B-284: (I)+(K.1.5), B-285: (I)+(K.1.6), B-286: (I)+(K.1.7), B-287: (I)+(K.1.8), B-288: (I)+(K.1.9), B-289: (I)+(K.1.10), B-290: (I)+(K.1.11), B-291: (I)+(K.1.12), B-292: (I)+(K.1.13), B-293: (I)+(K.1.14), B-294: (I)+(K.1.15), B-295: (I)+(K.1.16), B-296: (I)+(K.1.17), B-297: (I)+(K.1.18), B-298: (I)+(K.1.19), B-299: (I)+(K.1.20), B-300: (I)+(K.1.21), B-301: (I)+(K.1.22), B-302: (I)+(K.1.23), B-303: (I)+(K.1.24), B-304: (I)+(K.1.25), B-305: (I)+(K.1.26), B-306: (I)+(K.1.27), B-307: (I)+(K.1.28), B-308: (I)+(K.1.29), B-309: (I)+(K.1.30), B-310: (I)+(K.1.31), B-311: (I)+(K.1.32), B-312: (I)+(K.1.33), B-313: (I)+(K.1.34), B-314: (I)+(K.1.35), B-315: (I)+(K.1.36), B-316: (I)+(K.1.37), B-317: (I)+(K.1.38), B-318: (I)+(K.1.39), B-319: (I)+(K.1.40), B-320: (I)+(K.1.41), B-321: (I)+(K.1.42), B-322: (I)+(K.1.43), B-323: (I)+(K.1.44), B-324: (I)+(K.1.45), B-325: (I)+(K.1.46), B-326: (I)+(K.1.47), B-327: (I)+(K.1.48), B-328: (I)+(K.1.49), B-329: (I)+(K.1.50), B-330: (I)+(K.1.51), B-331: (I)+(K.1.52), B-332: (I)+(K.1.53), B-333: (I)+(K.1.54), B-334: (I)+(O.1.1), B-335: (I)+(O.1.2), B-336: (I)+(O.1.3), B-337: (I)+(O.1.4), B-338: (I)+(O.1.5), B-339: (I)+(O.1.6), B-340: (I)+(O.1.7), B-341: (I)+(O.1.8), B-342: (I)+(O.1.9), B-343: (I)+(O.1.10), B-344: (I)+(O.1.11), B-345: (I)+(O.1.12), B-346: (I)+(O.1.13), B-347: (I)+(O.1.14), B-348: (I)+(O.1.15), B-349: (I)+(O.1.16), B-350: (I)+(O.1.17), B-351: (I)+(O.1.18), B-352: (I)+(O.1.19), B-353: (I)+(O.1.20), B-354: (I)+(O.1.21), B-355: (I)+(O.1.22), B-356: (I)+(O.1.23), B-357: (I)+(O.1.24), B-358: (I)+(O.1.25), B-359: (I)+(O.1.26), B-360: (I)+(O.1.27), B-361: (I)+(O.1.28), B-362: (I)+(O.1.29), B-363: (I)+(O.1.30), B-364: (I)+(O.1.31), B-365: (I)+(O.1.32), B-366: (I)+(O.1.33), B-367: (I)+(O.1.34), B-368: (I)+(O.1.35), B-369: (I)+(O.1.36), B-370: (I)+(O.1.37), B-371: (I)+(O.1.38), B-372: (I)+(O.1.39), B-373: (I)+(O.1.40), B-374: (I)+(O.1.41), B-375: (I)+(O.1.42), B-376: (I)+(O.1.43), B-377: (I)+(O.1.44), B-378: (I)+(O.1.45), B-379: (I)+(O.1.46), B-380: (I)+(O.1.47), B-381: (I)+(O.1.48), B-382: (I)+(O.1.49), B-383: (I)+(O.1.50), B-384: (I)+(O.1.51), B-385: (I)+(O.1.52), B-386: (I)+(O.1.53), B-387: (I)+(O.1.54), B-388: (I)+(O.1.55), B-389: (I)+(O.1.56), B-390: (I)+(O.1.57), B-391: (I)+(O.1.58), B-392: (I)+(O.1.59), B-393: (I)+(O.1.60), B-394: (I)+(O.1.61), B-395: (I)+(O.1.62), B-396: (I)+(O.1.63), B-397: (I)+(O.1.64), B-398: (I)+(O.1.65), B-399: (I)+(O.1.66), B-400: (I)+(O.1.67), B-401: (I)+(O.1.68), B-402: (I)+(O.1.69), B-403: (I)+(O.1.70), B-404: (I)+(O.1.71), B-405: (I)+(O.1.72), B-406: (I)+(O.1.73), B-407: (I)+(O.1.74), B-408: (I)+(O.1.75), B-409: (I)+(O.1.76), B-410: (I)+(O.1.77), B-411: (I)+(O.1.78), B-412: (I)+(O.1.79), B-413: (I)+(O.1.80), B-414: (I)+(O.1.81), B-415: (I)+(O.1.82), B-416: (I)+(O.1.83), B-417: (I)+(O.1.84), B-418: (I)+(O.1.85), B-419: (I)+(O.1.86), B-420: (I)+(O.1.87), B-421: (I)+(O.1.88), B-422: (I)+(O.1.89), B-423: (I)+(O.1.90), B-424: (I)+(O.1.91), B-425: (I)+(O.2.1), B-426: (I)+(O.2.2), B-427: (I)+(O.2.3), B-428: (I)+(O.2.4), B-429: (I)+(O.2.5), B-430: (I)+(O.2.6), B-431: (I)+(O.2.7), B-432: (I)+(O.3.1), B-433: (I)+(O.3.2), B-434: (I)+(O.3.3), B-435: (I)+(O.3.4), B-436: (I)+(O.3.5), B-437: (I)+(O.3.6), B-438: (I)+(O.3.7), B-439: (I)+(O.3.8), B-440: (I)+(O.3.9), B-441: (I)+(O.3.10), B-442: (I)+(O.3.11), B-443: (I)+(O.3.12), B-444: (I)+(O.3.13), B-445: (I)+(O.3.14), B-446: (I)+(O.3.15), B-447: (I)+(O.3.16), B-448: (I)+(O.3.17), B-449: (I)+(O.3.18), B-450: (I)+(O.3.19), B-451: (I)+(O.3.20), B-452: (I)+(O.3.21), B-453: (I)+(O.3.22), B-454: (I)+(O.3.23), B-455: (I)+(O.3.24), B-456: (I)+(O.3.25), B-457: (I)+(O.3.26), B-458: (I)+(O.3.27), B-459: (I)+(O.3.28), B-460: (I)+(O.3.29), B-461: (I)+(O.3.30), B-462: (I)+(O.3.31), B-463: (I)+(O.3.32), B-464: (I)+(O.3.33), B-465: (I)+(O.3.34), B-466: (I)+(O.3.35), B-467: (I)+(O.3.36), B-468: (I)+(O.3.37), B-469: (I)+(O.3.38), B-470: (I)+(O.3.39), B-471: (I)+(O.3.40), B-472: (I)+(O.3.41), B-473: (I)+(O.3.42), B-474: (I)+(O.3.43), B-475: (I)+(O.3.44), B-476: (I)+(O.3.45), B-477: (I)+(O.3.46), B-478: (I)+(O.3.47), B-479: (I)+(O.3.48), B-480: (I)+(O.3.49), B-481: (I)+(O.3.50), B-482: (I)+(O.3.51), B-483: (I)+(O.3.52), B-484: (I)+(O.4.1), B-485: (I)+(O.4.2), B-486: (I)+(O.4.3), B-487: (I)+(O.4.4), B-488: (I)+(O.4.5), B-489: (I)+(O.4.6), B-490: (I)+(O.4.7), B-491: (I)+(O.4.8), B-492: (I)+(O.4.9), B-493: (I)+(O.4.10), B-494: (I)+(O.4.11), B-495: (I)+(O.4.12), B-496: (I)+(O.4.13), B-497: (I)+(O.4.14), B-498: (I)+(O.4.15), B-499: (I)+(O.5.1), B-500: (I)+(O.5.2), B-501: (I)+(O.6.1), B-502: (I)+(O.6.2), B-503: (I)+(O.6.3), B-504: (I)+(O.6.4), B-505: (I)+(O.6.5), B-506: (I)+(O.7.1), B-507: (I)+(O.7.2), B-508: (I)+(O.7.3), B-509: (I)+(O.7.4), B-510: (I)+(O.7.5), B-511: (I)+(O.8.1), B-512: (I)+(O.8.2), B-513: (I)+(O.8.3), B-514: (I)+(O.8.4), B-515: (I)+(O.8.5), B-516: (I)+(O.9.1), B-517: (I)+(O.9.2), B-518: (I)+(O.9.3), B-519: (I)+(O.10.1), B-520: (I)+(O.10.2), B-521: (I)+(O.10.3), B-522: (I)+(O.10.4), B-523: (I)+(O.11.1), B-524: (I)+(O.11.2), B-525: (I)+(O.11.3), B-526: (I)+(O.11.4), B-527: (I)+(O.11.5), B-528: (I)+(O.11.6), B-529: (I)+(O.11.7), B-530: (I)+(O.11.8), B-531: (I)+(O.11.9), B-532: (I)+(O.11.10), B-533: (I)+(O.11.11), B-534: (I)+(O.11.12), B-535: (I)+(O.11.13), B-536: (I)+(O.12.1), B-537: (I)+(O.12.2), B-538: (I)+(O.12.3), B-539: (I)+(O.12.4), B-540: (I)+(O.12.5), B-541: (I)+(O.12.6), B-542: (I)+(O.13.1), B-543: (I)+(O.13.2), B-544: (I)+(O.13.3), B-545: (I)+(O.14.1), B-546: (I)+(O.14.2), B-547: (I)+(O.14.3), B-548: (I)+(O.14.4), B-549: (I)+(O.15.1), B-550: (I)+(O.15.2), B-551: (I)+(O.15.3), B-552: (I)+(O.15.4), B-553: (I)+(O.15.5), B-554: (I)+(O.15.6), B-555: (I)+(O.15.7), B-556: (I)+(O.15.8), B-557: (I)+(O.15.9), B-558: (I)+(O.15.10), B-559: (I)+(O.15.11), B-560: (I)+(O.16.1), B-561: (I)+(O.17.1), B-562: (I)+(O.18.1), B-563: (I)+(O.18.2), B-564: (I)+(O.18.3), B-565: (I)+(O.18.4), B-566: (I)+(O.18.5), B-567: (I)+(O.19.1), B-568: (I)+(O.20.1), B-569: (I)+(O.20.2), B-570: (I)+(O.20.3), B-571: (I)+(O.20.4), B-572: (I)+(O.21.1), B-573: (I)+(O.21.2), B-574: (I)+(O.21.3), B-575: (I)+(O.21.4), B-576: (I)+(O.21.5), B-577: (I)+(O.21.6), B-578: (I)+(O.21.7), B-579: (I)+(O.22.1), B-580: (I)+(O.22.2), B-581: (I)+(O.22.3), B-582: (I)+(O.22.4), B-583: (I)+(O.23.1), B-584: (I)+(O.23.2), B-585: (I)+(O.23.3), B-586: (I)+(O.23.4), B-587: (I)+(O.24.1), B-588: (I)+(O.24.2), B-589: (I)+(O.24.3), B-590: (I)+(O.24.4), B-591: (I)+(O.24.5), B-592: (I)+(O.25.1), B-593: (I)+(O.25.2), B-594: (I)+(O.26.1), B-595: (I)+(O.26.2), B-596: (I)+(O.26.3), B-597: (I)+(O.26.4), B-598: (I)+(O.26.5), B-599: (I)+(O.26.6), B-600: (I)+(O.26.7), B-601: (I)+(O.26.8), B-602: (I)+(O.26.9), B-603: (I)+(O.26.10), B-604: (I)+(O.26.11), B-605: (I)+(O.26.12), B-606: (I)+(O.26.13), B-607: (I)+(O.26.14), B-608: (I)+(O.26.15), B-609: (I)+(O.26.16), B-610: (I)+(O.26.17), B-611: (I)+(O.26.18), B-612: (I)+(O.27.1), B-613: (I)+(O.28.1), B-614: (I)+(O.28.2), B-615: (I)+(O.28.3), B-616: (I)+(O.28.4), B-617: (I)+(O.28.5), B-618: (I)+(O.28.7), B-619: (I)+(O.28.8), B-620: (I)+(O.28.9), B-621: (I)+(O.28.10), B-622: (I)+(O.28.11), B-623: (I)+(O.28.12), B-624: (I)+(O.28.13), B-625: (I)+(O.28.14), B-626: (I)+(O.28.15), B-627: (I)+(O.28.16), B-628: (I)+(O.28.17), B-629: (I)+(O.28.18), B-630: (I)+(O.28.19), B-631: (I)+(O.28.20), B-632: (I)+(O.28.21), B-633: (I)+(O.28.22), B-634: (I)+(O.28.23), B-635: (I)+(O.28.24), B-636: (I)+(O.28.25), B-637: (I)+(O.28.26), B-638: (I)+(O.28.27), B-639: (I)+(O.28.28), B-640: (I)+(O.28.29), B-641: (I)+(O.28.30), B-642: (I)+(O.28.31), B-643: (I)+(O.28.42), B-644: (I)+(O.28.43), B-645: (I)+(O.28.44), B-646: (I)+(O.28.45), B-647: (I)+(O.28.46), B-648: (I)+(O.28.47), B-649: (I)+(O.28.48), B-650: (I)+(O.28.49), B-651: (I)+(O.28.50), B-652: (I)+(O.28.51), B-653: (I)+(O.28.52), B-654: (I)+(O.28.53), B-655: (I)+(O.28.54), B-656: (I)+(O.28.55), B-657: (I)+(O.28.56), B-658: (I)+(O.28.57), B-659: (I)+(O.28.58), B-660: (I)+(O.28.59), B-661: (I)+(O.28.60), B-662: (I)+(O.28.61), B-663: (I)+(O.28.62), B-664: (I)+(O.28.63), B-665: (I)+(O.28.64), B-666: (I)+(O.28.65), B-667: (I)+(O.28.66), B-668: (I)+(O.28.67), B-669: (I)+(O.28.68), B-670: (I)+(O.28.69), B-671: (I)+(O.28.70), B-672: (I)+(O.28.71), B-673: (I)+(O.28.72), B-674: (I)+(O.28.73), B-675: (I)+(O.28.74), B-676: (I)+(O.28.75), B-677: (I)+(O.28.76), B-678: (I)+(O.28.77), B-679: (I)+(O.28.78), B-680: (I)+(O.28.79), B-681: (I)+(O.28.80), B-682: (I)+(O.28.81), B-683: (I)+(O.28.82), B-684: (I)+(A.2.6), B-685: (I)+(A.3.24), B-686: (I)+(K.1.57), B-687: (I)+(K.1.58), B-688: (I)+(B.1.56), B-689: (I)+(B.1.57).

### I. SYNTHESIS EXAMPLES

Compounds I-1, I-3, I-6, I-7 and I-8 in Table I below were commercially available at the time the invention was made.

### Example I.1: Preparation of 2,2-difluoro-2-[4-[5-(trifluoromethyl)-1,2,4-oxadiazol-3-yl]phenyl]acetic acid (I-2)

### I.1.1) Preparation of 2-(4-cyanophenyl)-2,2-difluoro-acetic acid

A solution of ethyl 2-(4-cyanophenyl)-2,2-difluoro-acetate (for synthesis see WO 2018112094 and WO 2017076742) (4.7 g, 1.0 eq.) in a mixture of ethanol (100 mL) and water (10 mL) was treated with lithium hydroxide (0.75 g, 1.5 eq.) at room temperature until HPLC indicated complete conversion of the starting material. The mixture was concentrated under reduced pressure. The residue was dissolved in water and the aqueous layer was washed with methyl tert-butyl ether. The pH value of the aqueous layer was adjusted to 3 and the aqueous layer was extracted with methylene chloride. The combined organics were washed with water, dried over sodium sulfate and concentrated under reduced pressure to afford the title compound.

### I.1.2) Preparation of 2,2-difluoro-2-[4-[-N′-hydroxycarbamimidoyl]phenyl]acetic acid

A solution of 2-(4-cyanophenyl)-2,2-difluoro-acetic acid (2.6 g, 1 eq.), hydroxylamine hydrochloride (1.8 g, 2 eq.) and triethylamine (2.7 g, 2 eq.) in methanol (100 mL) was stirred at 40° C. for six hours. After cooling to ambient temperature, the mixture was stirred overnight. The mixture was concentrated under reduced pressure. The residue was dissolved in water and washed with methylene chloride. The aqueous layer was acidified with hydrochloric acid and the precipitation that formed was filtered off. Water was removed under reduced pressure to afford the title compound.

### I.1.3) Preparation of 2,2-difluoro-2-[4-[5-(trifluoromethyl)-1,2,4-oxadiazol-3-yl]phenyl]acetic acid

A solution of 2,2-difluoro-2-[4-[-N′-hydroxycarbamimidoyl]phenyl]acetic acid obtained in step I.1.2) (2.0 g, 1.0 eq.) in tetrahydrofuran (50 mL) was treated with trifluoroacetic anhydride (2.7 g, 1.5 eq.) at 50° C. for two hours. The mixture was concentrated under reduced pressure. The residue was dissolved into methyl tert-butyl ether and washed with hydrochloric acid (5% in water), successively, dried over sodium sulfate and concentrated under reduced pressure to afford the title compound I-2. Melting point: 119-121° C.

With due modification of the starting compounds, the procedures shown in the synthesis examples below were used to obtain compounds I-4 and I-5 in Table I.

TABLE I
Compounds I-1 to I-8 of formula I with physical data, wherein the meaning of A, n,
R^{A}, Y, and V are as defined in each line. The term “Cyp” in table I means that radicals
R³ and R⁴ together with the carbon atom to which they are bound form a cyclopropyl ring.

| Ex. no | A | n | R^{A} * | Y | V | m.p. [° C.]** |
|---|---|---|---|---|---|---|
| I-1 | (a.1) | 0 | — | direct bond | absent | 169-171° C. |
| I-2 | (a.1) | 0 | — | direct bond | —CF₂— | 119-121° C. |
| I-3 | (a.1) | 0 | — | direct bond | —CH₂— | 112° C. |
| I-4 | (a.1) | 0 | — | direct bond | Cyp | oil |
| I-5 | (a.1) | 1 | ortho-F | direct bond | absent | oil |
| I-6 | (a.1) | 1 | meta-F | direct bond | absent | ¹H NMR (400 MHz, DMSO-d₆): |
| | | | | | | δ (ppm): 13.66 (m, 1 H), 8.11 (t, |
| | | | | | | 1 H), 8.00 (d, 1 H), 7.94 (d, 1 H) |
| I-7 | (a.3) | 0 | — | direct bond | absent | ¹H NMR (400 MHz, DMSO-d₆): |
| | | | | | | δ (ppm): 9.30 (d, 1 H) 8.60 (dd, |
| | | | | | | 1 H) 8.24 (d, 1 H) |
| I-8 | (a.4) | 0 | — | direct bond | absent | ¹H NMR (600 MHz, DMSO-d₆): |
| | | | | | | δ (ppm): 13.81 (br. s, 1 H) 9.26 |
| | | | | | | (d, 1 H) 8.44-8.61 (m, 1 H), |
| | | | | | | 8.29 (d, 1 H) |

* orientation of radical R^{A} in relation to oxadiazole group
**m.p. = melting point

### II. BIOLOGICAL EXAMPLES FOR FUNGICIDAL ACTIVITY

Glass House Trials

The fungicidal action of the compounds of formula I was demonstrated by the following experiments: spray solutions were prepared in several steps. A mixture was prepared of acetone and/or dimethylsulfoxide and the wetting agent/emulsifier Wettol, which is based on ethoxylated alkylphenoles, in a relation (volume) solvent-emulsifier of 99 to 1 was added to the compound to give a total of 5 ml. Water was then added to a total volume of 100 ml. This stock solution was diluted with the described solvent-emulsifier-water mixture to the given concentration.

II.1) Curative Control of Soy Bean Rust on Soy Beans Caused by Phakopsora pachyrhizi

Leaves of potted soybean seedlings were inoculated with spores of Phakopsora pachyrhizi. To ensure the success of the artificial inoculation, the plants were transferred to a humid chamber with a relative humidity of about 95% and 20° C. to 24° C. for 24 hours. The next day the plants were cultivated for 3 days in a greenhouse chamber at 23° C. to 27° C. and a relative humidity between 60% and 80%. Then the plants were sprayed to run-off with the previously described spray solution, containing the concentration of active ingredient or their mixture as described below. The plants were allowed to air-dry. Then the trial plants were cultivated for 14 days in a greenhouse chamber at 23° C. to 27° C. and a relative humidity between 60% and 80%. The extent of fungal attack on the leaves was visually assessed as % diseased leaf area. In this test, the plants which had been treated with 63 ppm of the active compound I-1, 1-3 and I-5 showed a diseased leaf area of at most 7%, whereas the untreated plants showed 90% diseased leaf area.

II.2) Protective Control of Soy Bean Rust on Soy Beans Caused by Phakopsora pachyrhizi

Leaves of pot-grown soy bean seedlings were sprayed to run-off with an aqueous suspension, containing the concentration of active ingredient or their mixture as described below. The plants were allowed to air-dry. The trial plants were cultivated for 2 days in a greenhouse chamber at 23° C. to 27° C. and a relative humidity between 60% and 80%. Then the plants were inoculated with spores of Phakopsora pachyrhizi. To ensure the success the artificial inoculation, the plants were transferred to a humid chamber with a relative humidity of about 95% and 20° C. to 24° C. for 24 hours. The trial plants were cultivated for fourteen days in a greenhouse chamber at 23° C. to 27° C. and a relative humidity between 60% and 80%. The extent of fungal attack on the leaves was visually assessed as % diseased leaf area.

In this test, the plants which had been treated with 63 ppm of the active compound I-1, 1-3 and I-5 showed a diseased leaf area of at most 13%, whereas the untreated plants showed 90% diseased leaf area.

II.3) Curative Control of Brown Rust on Wheat Caused by Puccinia recondita

The first two developed leaves of pot-grown wheat seedling were dusted with spores of Puccinia recondita. To ensure the success the artificial inoculation, the plants were transferred to a humid chamber without light and a relative humidity of 95% to 99% and 20° C. to 24° C. for 24 hours. The next day the plants were cultivated for 3 days in a greenhouse chamber at 20° C. to 24° C. and a relative humidity between 65% and 70%. Then the plants were sprayed to run-off with an aqueous suspension, containing the concentration of active ingredient or their mixture as described below. The plants could air-dry. Then the trial plants were cultivated for 8 days in a greenhouse chamber at 20° C. to 24° C. and a relative humidity between 65% and 70%. The extent of fungal attack on the leaves was visually assessed as % diseased leaf area.

In this test, the plants which had been treated with 63 ppm of the active compound I-3 and I-5 showed a diseased leaf area of at most 7%, whereas the untreated plants showed 80% diseased leaf area.

II.3) Preventative Control of Brown Rust on Wheat Caused by Puccinia recondita

The first two developed leaves of potted wheat seedling were sprayed to run-off with previously described spray solution, containing the concentration of active ingredient or their mixture as described below. Seven days later the plants were dusted with spores of Puccinia recondita. To ensure the success the artificial inoculation, the plants were transferred to a humid chamber without light and a relative humidity of 95% to 99% and 20° C. to 24° C. for 24 hours. Then the trial plants were cultivated for 6 days in a greenhouse chamber at 20° C. to 24° C. and a relative humidity between 65% and 70%. The extent of fungal attack on the leaves was visually assessed as % diseased leaf area.

In this test, the plants which had been treated with 250 ppm of the active compound I-2, I-5 and I-6 showed a diseased leaf area of at most 12%, whereas the untreated plants showed 80% diseased leaf area.

II.4) Control of Powdery Mildew on Wheat Caused by Blumeria graminis f. sp. tritici

The first fully developed leaves of potted wheat were sprayed to run-off with previously described spray solution, containing the concentration of active ingredient or their mixture mentioned in the table below. The next day the treated plants were inoculated with spores of Blumeria graminis f. sp. tritici (=syn. Erysiphe garminis f. sp. tritici) by shaking heavily infested stock plants over the treated pots. After cultivation in the greenhouse for 7 days at 21° C. to 23° C. and a relative humidity between 40% and 70% the extent of fungal attack on the leaves was visually assessed as % diseased leaf area.

In this test, the plants which had been treated with 600 ppm of the active compound I-1 and I-4 showed a diseased leaf area of at most 9%, whereas the untreated plants showed 80% diseased leaf area.

II.5) Control of Culm Rot on Pearl Millet Caused by Fusarium culmorum

Pot-grown pearl millet seedlings were sprayed to run-off with previously described spray solution, containing the concentration of active ingredient or their mixture as described below. The plants were allowed to air-dry. The next day the plants were inoculated with a spore suspension of Fusarium culmorum in an aqueous biomalt or DOB solution. Then the trial plants were immediately transferred to a humid chamber. After 6 days at 23° C. to 25° C. and a saturated relative humidity, the extent of fungal attack on the leaves was visually assessed as % diseased leaf area.

In this test, the plants which had been treated with 600 ppm of the active compound I-4 showed a diseased leaf area of 7%, whereas the untreated plants showed 80% diseased leaf area.

1. (canceled)

2. The method according to claim 13, wherein A is phenyl, thiophenyl, pyridinyl, pyrimidinyl, pyridazinyl, or pyrazinyl.

3. The method according to claim 13, wherein A is of formula (a.1), 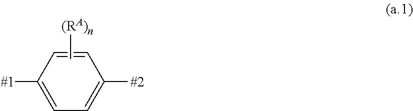
wherein #1 denotes the position which is bound to the trifluoromethyloxadiazole moiety and #2 denotes the position, which is connected to the group —Y—V—C(═O)—OH; and wherein n is 0, 1, 2 or 3 and R^{A} is as defined in claim 1.

4. The method according to claim 13, wherein n is 0, 1, or 2.

5. The method according to claim 13, wherein R^{A} is chlorine, fluorine, methyl, or methoxy.

6. The method according to claim 13, wherein n is 0.

7. The method according to claim 13, wherein Y is —O— or a direct bond.

8. The method according to claim 13, wherein R³ and R⁴ independently of each other are selected from the group consisting of hydrogen, fluorine, methyl, trifluoromethyl, and OCHF₂; or R³ and R⁴ together with the carbon atom to which they are bound form a cyclopropyl ring.

9. The method according to claim 13, wherein R³ and R⁴ are both fluorine.

10. The method according to claim 13, wherein Y is a direct bond and V is absent.

11. An agrochemical composition, which comprises at least one auxiliary surfactant and at least one compound of the formula I, or an N-oxide, or an agriculturally acceptable salt thereof, as defined in claim 13.

12. The agrochemical composition according to claim 11 further comprising seed, wherein the amount of a compound of the formula I, or the N-oxide, or an agriculturally acceptable salt thereof, is from 0.1 g to 10 kg per 100 kg of seed.

13. A method for combating phytopathogenic harmful fungi, comprising treating the fungi, the plants, the soil or seeds to be protected against fungal attack, with an effective amount of at least one compound of formula I, or an N-oxide, or an agriculturally acceptable salt thereof, 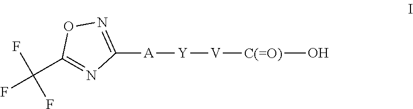
wherein:
A is phenyl, or a 5- or 6-membered aromatic heterocycle; wherein the ring member atoms of the aromatic heterocycle include besides carbon atoms 1, 2, 3 or 4 heteroatoms selected from N, O and S as ring member atoms; and with the provision that the aromatic heterocycle cannot contain 2 contiguous atoms selected from O and S; and wherein the phenyl ring or the 5- or 6-membered aromatic heterocycle is unsubstituted or substituted with n identical or different groups R^{A}; wherein
n is 0, 1, 2, 3, or 4;
R^{A} is halogen, cyano, C₁-C₆-alkyl, C₁-C₆-haloalkyl, C₁-C₆-alkoxy, or C₁-C₆-haloalkoxy;
Y is a direct bond, —O—, or —S—;
V is a divalent moiety —CR³R⁴—; wherein
R³, R⁴ independently of each other are selected from the group consisting of hydrogen, hydroxy, halogen, cyano, C₁-C₄-alkyl, C₂-C₄-alkenyl, C₂-C₄-alkynyl, C₁-C₄-alkoxy C₁-C₄-haloalkyl, and C₁-C₄-haloalkoxy; or R³ and R⁴ together with the carbon atom to which they are bound form a cyclopropyl ring;
or, if Y is a direct bond, V is absent, with the exception of a method practiced for the therapeutic treatment of the human or animal body.
